(19) United States
(12) Patent Application Publication
(10) Pub. No.: US 2026/0170721 A1
(43) Pub. Date: Jun. 18, 2026

(54) UTILIZING RELATIONAL PORTALS TO APPLY SPATIAL OR STYLE TRANSITIONS ON PORTIONS OF VECTOR OBJECTS

(71) Applicant: Adobe Inc., San Jose, CA (US)

(72) Inventors: Ronak Mehta, UDAIPUR (IN); Rishav Agarwal, Howrah (IN); Nitin Sharma, Gurugram (IN); Apurva Kumar, Patna (IN)

(21) Appl. No.: 18/980,103

(22) Filed: Dec. 13, 2024

(51) Int. Cl. G06T 11/60; G06T 11/20

(52) U.S. Cl. CPC G06T 11/60; G06T 11/23

(57) ABSTRACT

The present disclosure is directed toward systems, methods, and non-transitory computer readable media that generate relational vector portals and cause a vector object traversing an entry portal to exit out of a linked exit portal by performing spatial and/or style transitions on the vector object. In particular, the disclosed systems generate an entry portal aligned with a vector path. Furthermore, the disclosed systems generate an exit portal linked to the entry portal. Moreover, the disclosed systems move a vector object to at least partially traverse the entry portal. In addition, the disclosed systems generate a transformed vector object by causing a portion of the vector object traversing the entry portal to exit out of the exit portal.

### BACKGROUND

Advancements in computing devices and digital content design systems have led to innovative developments in computer image design and design software. For example, certain digital content design applications enable the editing and manipulation of vector content to generate a variety of visual designs. For example, the existing workflows of digital content design applications allow for arranging and manipulating vector content within digital designs. Indeed, digital design applications provide options to display a variety of vector objects within a graphical user interface. However, despite these advances, existing image editing systems have a number of shortcomings with regard to flexibility and efficiency when displaying either multiple and/or partial appearances for a single vector object.

### SUMMARY

One or more embodiments provide benefits and/or solve one or more of the foregoing or other problems in the art with systems, methods, and non-transitory computer readable storage media that generate relational vector portals and cause a vector object traversing an entry portal to exit out of a linked exit portal by performing spatial and/or style transitions on the vector object. In particular, the disclosed systems generate an entry portal such that a vector object traversing the entry portal gradually becomes invisible upon crossing the entry portal. In some embodiments, the disclosed systems generate an exit portal linked to the entry portal, such that a copy of the portion of the vector object that vanishes upon traversing the entry portal emerges from the exit portal by transforming one or more of a position, orientation, scale, or style of the copy of the post-intersection object portion. In some cases, the disclosed systems generate multiple exit portals linked to the entry portal, such that copies of the portion of the vector object that vanishes upon transversing the entry portal emerges at all of the linked exit portals. In certain cases, the disclosed systems generate a bidirectional portal where an entry portal and an exit portal are aligned with opposite sides of the same vector path.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a relational vector portal system in accordance with one or more embodiments;

FIG. 2 illustrates an example overview of generating a transformed vector object for a vector object that traverses an entry portal in accordance with one or more embodiments;

FIG. 3 illustrates an example of determining a directional flow axis for linked portals in accordance with one or more embodiments;

FIG. 4 illustrates an example of generating clipping groups for a vector object and a portal in accordance with one or more embodiments;

FIG. 5 illustrates an example of utilizing optimized rendering to display multiple transformed vector objects utilizing the relational vector portal system in accordance with one or more embodiments;

FIG. 6 illustrates an example of generating a transformed vector object utilizing a bidirectional portal to apply a style transformation in accordance with one or more embodiments;

FIG. 7A illustrates an example of performing a spatial transformation on a vector object with the relational vector portal system in accordance with one or more embodiments;

FIG. 7B illustrates an example of performing multiple spatial transformations on a vector object utilizing a one-to-many relationship between one entry portal and multiple exit portals with the relational vector portal system in accordance with one or more embodiments;

FIG. 8 illustrates an example of rendering multiple transformed vector objects utilizing a one-to-many relationship between one entry portal and one exit portal with the relational vector portal system in accordance with one or more embodiments;

FIG. 9 illustrates an example of rendering transformed vector objects utilizing multiple sequential entry and exit portals with the relational vector portal system in accordance with one or more embodiments;

FIGS. 10A-10C illustrate examples of rendering a transformed vector object by changing an appearance style using a bidirectional portal with the relational vector portal system in accordance with one or more embodiments;

FIG. 11 illustrates a diagram of an example architecture of the relational vector portal system in accordance with one or more embodiments;

FIG. 12 illustrates a flowchart of a series of acts for generating a transformed vector object for a vector object utilizing portals in accordance with one or more embodiments; and

FIG. 13 illustrates a block diagram of an example computing device in accordance with one or more embodiments.

### DETAILED DESCRIPTION

This disclosure describes one or more embodiments of a relational vector portal system that utilizes linked relational vector portals to transport portions of vector objects from one spatial location to another spatial location while controlling the visibility, orientation, style, and appearance of the transported portion. For example, the relational vector portal system generates linked relational vector portals that include an entry portal and one or more exit portals. Utilizing the link between the relational vector portals, the relational vector portal system causes vector objects that intersect with the entry portal to emerge from the exit portal(s) by performing a spatial transformation on the vector objects. Furthermore, embodiments of the relational vector portal system perform style transformation(s) on the vector objects to modify the visibility, orientation, style, and/or appearance of the transported portion of the vector object that emerges from the exit portal(s). In some embodiments, the relational vector portal system dynamically adjusts the spatial and/or style transformations for the vector objects based on real-time modifications to the relational vector portals.

To illustrate, in certain embodiments, the relational vector portal system generates an entry portal linked to an exit portal, such that a copy of a portion of a vector object (e.g., the post-intersection object portion) vanishes upon traversing the entry portal and emerges from the exit portal. In some cases, the relational vector portal system generates an entry portal located at a different location than the linked exit portal. In certain cases, the relational vector portal system generates a bidirectional portal such that an entry portal and a linked exit portal share the same vector spline (e.g., the entry portal and exit portal are aligned with opposite sides of the same vector spline). In certain embodiments, the relational vector portal system transforms the copy of the post-intersection object portion at the exit portal by altering one or more of a position, orientation, scale, or style of the copy of the post-intersection object portion.

In one or more embodiments, the relational vector portal system determines clipping groups for vector objects traversing the relational portals. For example, the relational vector portal system determines directional flow axes for the relational portals to aid in smart clipping when using clipping groups. In some cases, the relational vector portal system determines directional flow axes for portal splines aligned with, or representing, the relational portals. In some cases, the relational vector portal system reduces the portal splines into line primitives (e.g., polylines) and determines minimum area bounding boxes for the polylines. Using the minimum area bounding boxes, in some embodiments, the relational vector portal system determines directional flow axes for the polylines (and the associated relational portals).

To illustrate, the relational vector portal system determines clipping groups for portions of a vector object based on an intersection of the vector object with an entry portal. In one or more embodiments, the relational vector portal system determines the clipping groups by determining a composite bounding box that encompasses both the vector object and the entry portal. For example, the relational vector portal system determines a composite bounding box from a union of the bounds for the vector object and the bounds for the entry portal. In some cases, the relational vector portal system divides the bounding box at the intersection of the bounding box and the entry portal to determine a pre-intersection clipping group incorporating the pre-intersection object portion that precedes the entry portal and the associated clipping path. Relatedly, in some cases, the relational vector portal system divides the bounding box at the intersection of the bounding box and the entry portal to determine a post-intersection clipping group incorporating the post-intersection object portion that succeeds the entry portal and the associated clipping path.

In certain embodiments, the relational vector portal system generates a one-to-many relationship between entry portals and exit portals. For example, the relational vector portal system utilizes a one-to-many correlation between one entry portal and multiple exit portals, such that multiple copies of the post-intersection object portion emerge at multiple linked exit portals. For example, based on the intersection of a vector object with an entry portal, the relational vector portal system displays multiple copies of a post-intersection object portion at multiple positions associated with multiple exit portals. Relatedly, in some cases, the relational vector portal system uses a one-to-many relationship to display multiple copies of a post-intersection object portion at one exit portal. For example, based on the intersection of a vector object with an entry portal, the relational vector portal system displays multiple copies of a post-intersection object portion at multiple positions associated with one exit portal (e.g., successively aligned with the exit portal). In some embodiments, the relational vector portal system utilizes optimized rendering techniques such as batching and instanced rendering to render the multiple copies of the post-intersection object portion in a single render call.

Furthermore, in some embodiments, the relational vector portal system applies style transformations to the copies of the post-intersection object portions. For example, the relational vector portal system utilizes a post-operation transmutation to apply a graphic style associated with an exit portal to the copy of the post-intersection object portion that emerges from the exit portal. In some embodiments, the relational vector portal system utilizes a bidirectional portal to create the visual impression of a single vector object which changes style at the path intersection of the vector object with the bidirectional portal. In some embodiments, the relational vector portal system applies a stylistic transformation to the copy of the post-intersection object portion in conjunction with a spatial transformation (e.g., a relational portal with an entry portal located at a different position than a linked exit portal).

As mentioned, existing design systems have a number of technical shortcomings, particularly in terms of efficiency and flexibility when manipulating vector objects. For example, existing design systems are inflexible. In particular, existing design systems lack a way to define a style or appearance transition within a single vector object. For example, to achieve the appearance of a style or appearance transition within a single vector object using existing design systems, user devices must divide the single vector object into multiple divided vector objects and coordinate any modifications between the divided vector objects (such as spatial adjustments, scaling, stylization). The inflexibility of existing design systems is due in part to an inflexible reliance on fixed methods for manipulating vector objects.

As a result of this lack, many existing design systems are operationally inefficient and require multiple device interactions to transform portions of a single vector object. For example, to display different appearances for different portions of a vector object, existing design systems first divide the vector object and then individually modify each of the divided vector objects, which can require an excessive number of device interactions. Furthermore, changes to the geometry and/or textual content of the original vector object exacerbates these inefficiencies as, with current design systems, changes to the original vector object are not reproduced in the divided vector objects. Thus, changes to the original vector object require follow-on device interactions to re-divide the updated vector object into updated divided vector objects and to re-apply the different styles individually to each updated divided vector object.

Relatedly, when positioning multiple copies of a vector object with different orientations and/or visibility for display, existing design systems position and modify each copy individually. To make updates or adjustments to the multiple copies, existing systems require user devices to adjust each copy individually, often repeating similar steps for positioning, rotating, scaling, and style for each copy. In complex or dynamic designs where multiple copies of the vector object need to be realigned or updated frequently, the device interactions required by existing design systems can increase dramatically.

Relatedly, existing design systems are computationally inefficient. For example, with existing design systems that provide an interface to select a portion of a vector object and generate multiple copies of the selection require multiple CPU-GPU communications to render each copy. In some cases, existing design systems repeat similar calculations for each vector object, such as recalculating transformations or style adjustments for every copy of a vector object. For example, without a streamlined way to batch-edit or adjust the multiple copies, existing design systems typically perform individual operations to divide the vector object into portions, select a portion of the vector object to copy, and render the multiple copies of the selected portion, resulting in inefficient processing and an increased computational load.

As suggested above, embodiments of the relational vector portal system overcome these and other disadvantages of existing design systems. For example, the relational vector portal system provides advantages in flexibility over existing design systems. Unlike existing design systems which lack the ability to apply transformations selectively to specific portions of vector objects, the relational vector portal system provides a method to selectively transform portions of vector objects and provide multiple or partial appearances for a single graphic object. Unlike the existing systems which require a user device to divide a vector object into divided vector objects (e.g., separate vector objects), the relational vector portal system maintains the vector object (e.g., as a modifiable undivided object) and performs partial transformations for the vector object. By performing transformations using post-intersection object portions of the vector object, the relational vector portal system transforms a portion of the vector object based on the intersection of the vector object with the entry portal. Using relational portals as described herein, the relational vector portal system can generate flexible real-time updates for the partial transformations to a post-intersection object portion based on changes to the vector object or the relational portals (e.g., by moving/modifying either the vector object or the relational portals).

In addition, in one or more embodiments, the relational vector portal system provides advantages in operational efficiency over existing design systems. Unlike existing design systems that require user devices to separate vector objects and apply transformations to each portion of a vector object individually, embodiments of the relational vector portal system apply selective transformations to one or more copies of the post-intersection object portion without requiring additional user device interactions. As mentioned, the relational vector portal system automatically provides real-time updates to the post-intersection object portion based on changes to the vector object or relational portals. For example, the relational vector portal system utilizes an observer mechanism and lightweight hit test calls to track changes to the vector object and apply transformations to copies of the post-intersection object portion of the vector object based on an intersection of the vector object with the entry portal. Furthermore, embodiments of the relational vector portal system utilize batching to seamlessly generate multiple copies of the post-intersection object portion at multiple linked exit portals simultaneously with a single draw call without requiring additional user device interactions.

Relatedly, the relational vector portal system provides computational efficiencies over existing design systems. For example, by utilizing efficient memory management techniques, such as instancing and shared data structures, the relational vector portal system reduces memory overhead. For example, the relational vector portal system utilizes batching to provide multiple copies of the post-intersection object portion to the graphical user interface of a client device in a single draw call. To illustrate, the relational vector portal system performs instanced rendering at each of the exit portals to provide instanced versions of the post-intersection object portions for display on the graphical user interface, reducing the CPU-GPU communication required each time a post-intersection object portion is rendered to a single GPU draw call.

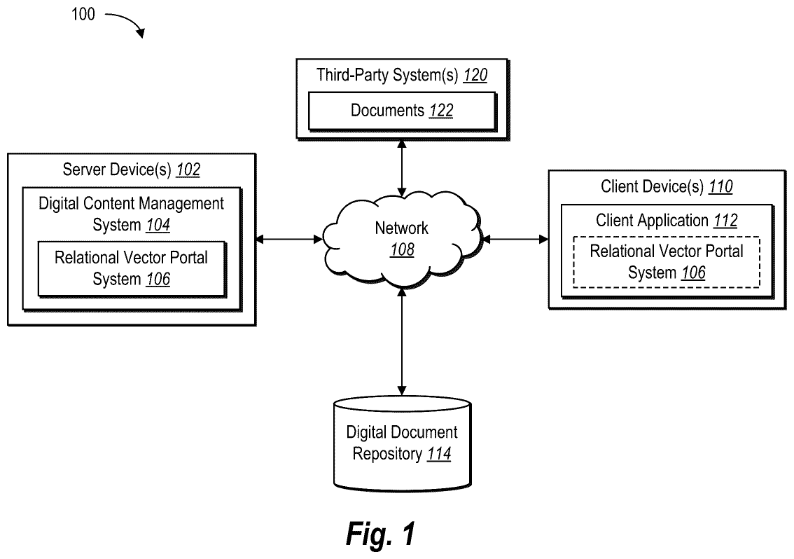

Additional detail regarding the relational vector portal system will now be provided with reference to the figures. For example, FIG. 1 illustrates a schematic diagram of an exemplary system environment (e.g., environment 100) in which a relational vector portal system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the relational vector portal system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

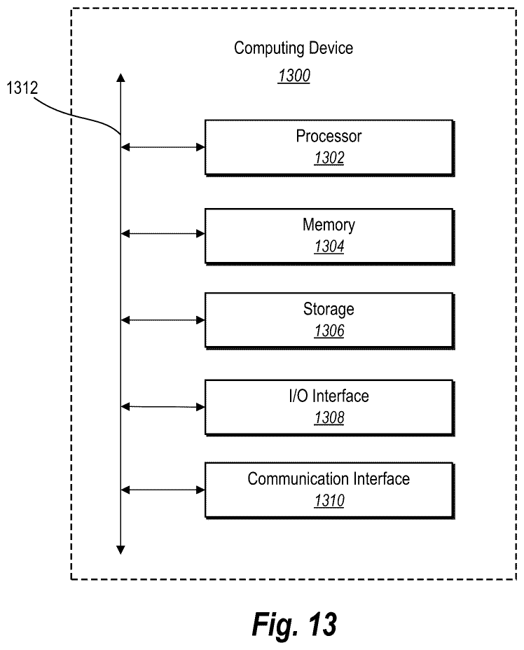

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 13). Moreover, the server device(s) 102 and the client device(s) 110 include one of a variety of computing devices (including one or more computing devices as discussed in greater detail with relation to FIG. 13).

As illustrated in FIG. 1, the environment 100 includes the server device(s) 102 and the digital content management system 104. The server device(s) 102 utilizes the digital content management system 104 to generate, track, store, process, receive, and transmit electronic data including vector objects, relational portals, and transformed vector objects. For example, the server device(s) 102 receives or monitors interactions across the client device(s) 110. In some embodiments, the server device(s) 102 transmits content to the client device(s) 110 to cause the client device(s) 110 to display content associated with generating transformed vector objects. For example, the server device(s) 102 presents the vector objects, relational portals, and transformed vector objects to client device(s) 110 and displays the vector objects, relational portals, and transformed vector objects on the client device(s) 110 with the vector objects and transformed vector objects displayed corresponding to system need (e.g., provides vector objects and transformed vector objects for display via the client application 112). The server device(s) 102 further accesses and utilizes the digital document repository 114 to store and retrieve information such as vector objects, relational portals, clipping paths, clipping groups, transformed vector objects, and/or other data.

Additionally, the server device(s) 102 includes all, or a portion of, the relational vector portal system 106. For example, the relational vector portal system 106 operates on the server device(s) 102 to access digital content (including vector objects, relational portals, and transformed vector objects), determine digital content changes, and provide localization of content changes to the client device(s) 110. In one or more embodiments, via the server device(s) 102, the relational vector portal system 106 generates and displays vector objects, relational portals, and transformed vector objects based on the client device(s) 110 input. Example components of the relational vector portal system 106 will be described below with regard to FIG. 13.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 13. Some embodiments of client device(s) 110 are operated by a user to perform a variety of functions via client application 112 such as the generation of the transformed vector objects. The client device(s) 110 include one or more applications (e.g., the client application 112) that access, edit, modify, store, and/or provide, for display, vector objects, relational portals, clipping paths, clipping groups, and transformed vector objects. For example, in some embodiments, the client application 112 include a software application installed on the client device(s) 110. In other cases, however, the client application 112 include a web browser or other application that accesses a software application hosted on the server device(s) 102.

In one or more embodiments, the relational vector portal system 106 is implemented in whole, or in part, by the individual elements of the environment 100. Indeed, as shown in FIG. 1, the relational vector portal system 106 is implemented with regard to the server device(s) 102 and the client device(s) 110. In particular embodiments, the relational vector portal system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the relational vector portal system 106 on the client device(s) 110 represents and/or provides the same or similar functionality as described herein in connection with the relational vector portal system 106 on the server device(s) 102. In some embodiments, the relational vector portal system 106 on the server device(s) 102 supports the relational vector portal system 106 on the client device(s) 110.

In some embodiments, the relational vector portal system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., user interactions). In response, the relational vector portal system 106 on the server device(s) 102 generates vector objects, relational portals, clipping paths, clipping groups, and transformed vector objects. The server device(s) 102 then provides the vector objects, relational portals, clipping paths, clipping groups, and transformed vector objects to the client device(s) 110.

In some embodiments, the relational vector portal system 106 includes the third-party system(s) 120 and documents 122. To illustrate, in one or more embodiments, the relational vector portal system 106 interacts with content and services hosted on the third-party system(s) 120. To illustrate, in one or more embodiments, the relational vector portal system 106 accesses a web page or computing application supported by the third-party system(s) 120. The third-party system(s) 120 provide input to the relational vector portal system 106 and documents 122 (e.g., vector objects). In response, the relational vector portal system 106 generates/modifies digital content including generating vector objects, relational portals, clipping paths, clipping groups, and transformed vector objects. The relational vector portal system 106 then provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

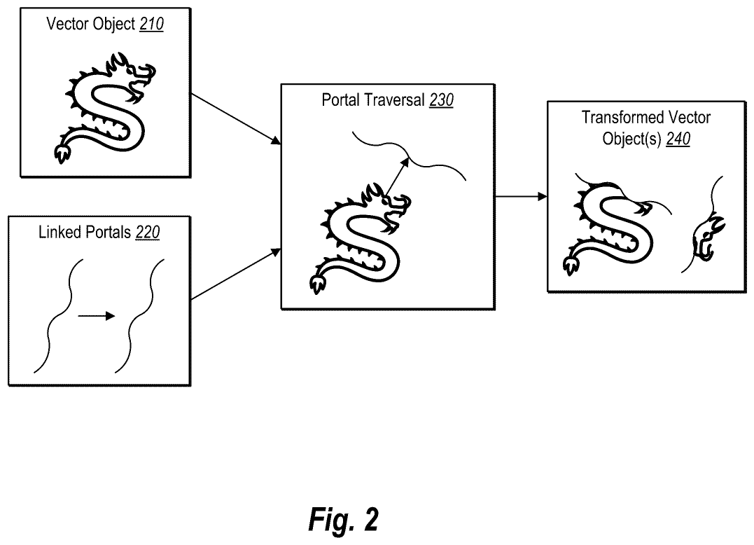

As previously mentioned, in one or more embodiments, the relational vector portal system 106 generates a transformed vector object from the post-intersection object portion that transverses an entry portal. In this way, the relational vector portal system 106 manages multiple copies of a vector object simultaneously as well as provides multiple/partial appearances for a single vector object. For instance, FIG. 2 illustrates an example overview of generating a transformed vector object for a vector object that traverses an entry portal in accordance with one or more embodiments. Additional detail regarding the various acts of FIG. 2 is provided thereafter with reference to subsequent figures.

As shown, the relational vector portal system 106 determines a vector object 210 and linked portals 220. As used herein, the linked portals 220 includes or refers to relational portals including an entry portal with a specific connection or relationship to one or more exit portal(s). In some cases, the relational vector portal system 106 establishes a link between an entry portal and the exit portal(s) to control the transformation of a vector object from the entry portal to one or more exit portal(s). An entry portal includes or refers to a designated boundary or area linked to an exit portal where vector objects enter a specific transformation or interaction sequence (e.g., clipping, masking, transforming). An exit portal includes or refers to a designated boundary or area linked to an exit portal where vector objects exit a defined path or interaction sequence (e.g., applying transformations). For example, for a vector object traversing the entry portal, the relational vector portal system 106 maintains a pre-intersection object portion of the vector object that precedes the entry portal for display (at the position of the entry portal) and removes the post-intersection object portion of the vector object crosses the entry portal from display (at the position of the entry portal). Furthermore, the relational vector portal system 106 utilizes the linked portals 220 to cause a transformed copy of the post-intersection object portion of the vector object to emerge at the position of the linked exit portal.

In certain embodiments, the relational vector portal system 106 aligns the entry portal with a vector path (e.g., vector spline) and the exit portal with a vector path. In one or more embodiments, the relational vector portal system 106 utilizes a one-to-one correlation between an entry portal linked to a single exit portal. In some cases, the relational vector portal system 106 positions the entry portal and the exit portal at different positions on a graphical user interface. In some cases, the relational vector portal system 106 positions the entry portal and the exit portal at the same position on a graphical user interface using a bidirectional portal wherein the entry portal and the exit portal are aligned to opposite sides of a same vector path.

In some cases, the relational vector portal system 106 utilizes a one-to-many correlation between an entry portal linked to one or more exit portals. For example, the relational vector portal system 106 utilizes a one-to-many correlation between one entry portal and multiple exit portals, such that multiple copies of the post-intersection object portion emerge at multiple linked exit portals. In some cases, based on the intersection of a vector object with an entry portal, the relational vector portal system 106 utilizes a one-to-many correlation to display multiple copies of a post-intersection object portion at multiple positions associated with a single exit portal.

As further shown in FIG. 2, the relational vector portal system 106 detects a portal transversal 230 by the vector object 210. In one or more embodiments, the relational vector portal system 106 generates the entry portal as a listening object using an observer mechanism to track changes to other vector objects on the canvas. For example, the relational vector portal system 106 performs a lightweight hit test call to the entry portal for vector objects (except the linked exit portal) that transform on the canvas. In some embodiments, the relational vector portal system 106 optimizes the hit call based on various factors such as considering only vector objects that are above z-order (e.g., layer order), non-locked, or non-hidden as valid intersecting vector objects for the entry portal. In this way, the relational vector portal system 106 utilizes the observer mechanism to monitor when vector objects traverse entry portal(s) without inefficiently checking every vector object on a vector image.

In some cases, the relational vector portal system 106 generates, for display on a graphical user interface, a transformed vector object(s) 240 by causing a copy of a portion of the vector object traversing an entry portal to exit out of an exit portal. As used herein, the transformed vector object(s) 240 includes or refers to a vector object generated from a source vector object by performing one or more modifications to properties of the source vector object, such as transformations to position, size, shape, scale, orientation, and/or style. For example, the relational vector portal system 106 generates the transformed vector object(s) 240 by transforming one or more copies of the post-intersection object portion of the vector object 210.

In some embodiments, upon detecting an intersection of the vector object 210 with the entry portal, the relational vector portal system 106 generates the transformed vector object(s) 240. As part of generating the transformed vector object(s) 240, in some embodiments, the relational vector portal system 106 determines clipping groups for the vector object 210 based on an intersection of the vector object 210 with the entry portal. From the clipping groups, the relational vector portal system 106 determines a pre-intersection object portion and a post-intersection object portion of the vector object 210. In certain embodiments, the relational vector portal system 106 generates the transformed vector object(s) 240 by applying transformation(s) to one or more copies of the post-intersection object portion of the vector object 210.

To illustrate, in some cases, the relational vector portal system 106 generates the transformed vector object(s) 240 by applying transformations(s) such as altering one of a style, a spatial position, an orientation, or a scale of a copy of the post-intersection object portion. In some cases, the relational vector portal system 106 generates the transformed vector object(s) 240 using a spatial transformation that repositions a copy of the post-intersection object portion by duplicating and projecting the post-intersection object portion through the linked exit portal(s). In some cases, the relational vector portal system 106 generates the transformed vector object(s) 240 using a style transformation by applying one or more style(s) to a copy of the post-intersection object portion displayed at the linked exit portal(s) (e.g., skew, color, drop shadow, opacity, gradient, etc.). In some cases, the relational vector portal system 106 generates the transformed vector object(s) 240 using a transformation resizing, re-orienting, or duplicating a copy of the post-intersection object portion displayed at the linked exit portal(s).

In some cases, when the relational vector portal system 106 detects a modification to the vector object 210 the relational vector portal system 106 re-generates the transformed vector object(s) 240. For example, when the relational vector portal system 106 determines a change to the vector object 210, the relational vector portal system 106 re-determines the clipping paths for the vector object 210 and re-applies the transformations associated with the linked exit portal(s). In this way, the relational vector portal system 106 utilizes the relational portals to dynamically respond to changes to the vector object 210 and maintains accurate real-time transformations for the transformed vector object(s) 240 that incorporate modifications to the vector object 210.

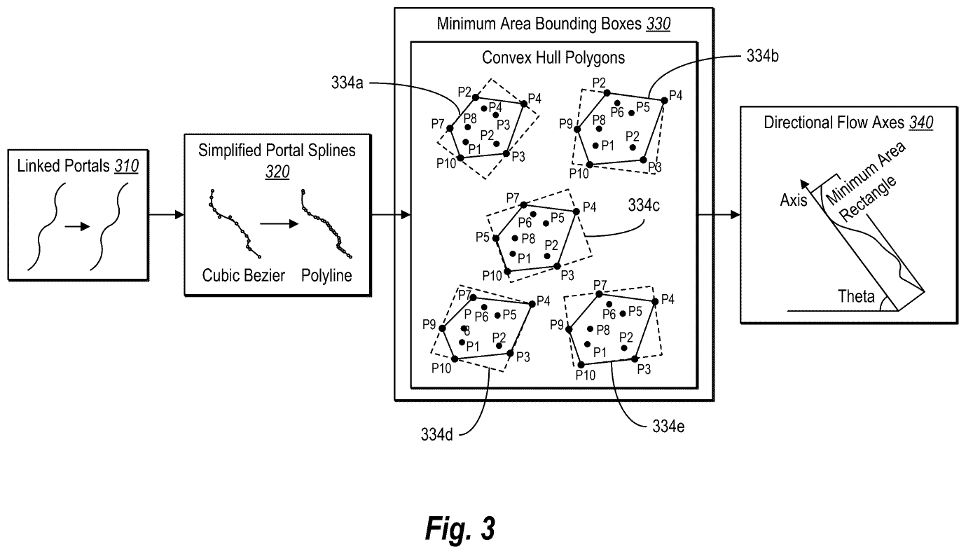

As mentioned, the relational vector portal system 106 utilizes clipping paths to transform copies of the post-intersection object portion of a vector object that traverses an entry portal. In one or more embodiments, when determining the clipping paths, the relational vector portal system 106 utilizes a directional flow axis for the relational portals. FIG. 3 illustrates an example of determining a directional flow axis for linked portals in accordance with one or more embodiments.

In certain embodiments, the relational vector portal system 106 generates an exit portal such that the post-intersection object portion re-emerges from linked exit portal(s), oriented according to the directional flow axis of the vector paths associated with the linked portals 310. To elaborate, in one or more embodiments, the relational vector portal system 106 generates or determines linked portals 310 which includes an entry portal and one or more exit portals. For example, the relational vector portal system 106 establishes links or correlations between an entry portal and one or more exit portal(s) to control the transfer of vector objects between the entry portal and the exit portal(s). In certain embodiments, the relational vector portal system 106 generates the linked portals 310 by aligning and/or assigning the entry portals and the exit portal(s) to vector paths (e.g., vector splines, cubic Bézier curves).

As also shown, the relational vector portal system 106 generates simplified portal splines 320 for the vector paths associated with the linked portals 310. In one or more embodiments, the relational vector portal system 106 reduces the vector paths into line primitives to generate the simplified portal splines 320. By generating the simplified portal splines 320, the relational vector portal system 106 extracts the points required to compose the polylines for the linked portals 310. In some cases, the relational vector portal system 106 utilizes an algorithm such as Algorithm 1 below to flatten vector paths into polylines to generate the simplified portal splines 320:

Algorithm 1: Flatten Vector Path into Line Segments

| | |
|---|---|
| 1: | procedure CUBICBEZIER(t, P₀, P₁, P₂, P₃) |
| 2: | return (1 − t)³P₀ + 3(1 − t)²tP₁ + 3(1 − t)t²P₂ + t³P₃ |
| 3: | procedure SUBDIVIDE(P₀, P₁, P₂, P₃, tolerance) |
| 4: | t_{mid} ← 0.5 |
| 5: | Q₀ ← CubicBezier(t_{mid}, P₀, P₁, P₂, P₃) |
| 6: | Q₁ ← CubicBezier(t_{mid}, P₁, P₂, P₃, P₃) |
| 7: | R₀ ← CubicBezier(t_{mid}, Q₀, Q₁, Q₁, Q₁) |
| 8: | if \|\|R₀ − P₀\|\| + \|\|R₀ − P₃\|\| < tolerance then |
| 9: | return [P₀, R₀, P₃] |
| 10: | else |
| 11: | return Subdivide(P₀, Q₀, R₀, P₃, tolerance) |
| 12: | procedure FLATTENCUBICBEZIER(P₀, P₁, P₂, P₃, tolerance) |
| 13: | subdivided_points ← Subdivide(P₀, P₁, P₂, P₃, tolerance) |
| 14: | return subdivided_points |

As described in Algorithm 1, in one or more embodiments, the relational vector portal system 106 generates polylines by flattening the vector paths within a specified tolerance. For example, the relational vector portal system 106 defines a portal spline for the vector path using four control points (e.g., P₀, P₁, P₂, P₃) and utilizes a recursive procedure to divide the portal spline into segments that approximate a polyline using segments that approximate the portal spline within the specified tolerance. As also described in Algorithm 1, the relational vector portal system 106 determines a list of points that represent the polylines as a sequence of straight line segments.

Furthermore, in some embodiments, the relational vector portal system 106 simplifies the list of points for the polylines as determined in Algorithm 1. For example, the relational vector portal system 106 utilizes a simplification process to remove redundant points or excess points that represent unnecessarily fine details of the vector paths. For example, the relational vector portal system 106 utilizes an algorithm such as Algorithm 2 below to simplify the polylines and/or remove redundant points to generate the simplified portal splines 320:

Algorithm 2 Point Simplification Algorithm

| | |
|---|---|
| 1: | procedure SIMPLIFYPOINTS(originalPoints, tolerance) |
| 2: | simplifiedPoints ← [originalPoints[0] [symbol] Initialize with the |

first point

| | |
|---|---|
| 3: | for i ← 1 to length(originalPoints) − 2 do |
| 4: | segment ← [originalPoints[i − 1], originalPoints[i], |

originalPoints[i + 1]]

| | |
|---|---|
| 5: | if Distance(segment) > tolerance then |
| 6: | simplifiedPoints.append(originalPoints[i]) |
| 7: | simplifiedPoints.append(originalPoints[length(originalPoints) − |

1]) [symbol] Include the last point

| | |
|---|---|
| 8: | return simplifiedPoints |
| 9: | function DISTANCE(segment) [symbol] Calculate the distance between |

two consecutive points in a segment

| | |
|---|---|
| 10: | return \|\|segment[0] − segment[2]\|\| |

As described in Algorithm 2, in one or more embodiments, the relational vector portal system 106 reduces the number of points in the polylines while maintaining the general shape of the vector paths. For example, the relational vector portal system 106 simplifies the polylines by removing excess points that are within a tolerance distance of each other. As described in Algorithm 2, the relational vector portal system 106 removes points that do not significantly deviate (e.g., a distance tolerance) from a straight line, thereby reducing the total number of points for the simplified portal splines 320.

As further shown in FIG. 3, in some embodiments, the relational vector portal system 106 determines the minimum area bounding boxes 330 for the simplified portal splines 320. For example, the relational vector portal system 106 determines the minimum area bounding boxes 330 by determining the minimum area rectangles that enclose the simplified portal splines 320.

To illustrate, the relational vector portal system 106 finds a minimum area rectangle which encloses each of the simplified portal splines 320 using a set of points VP=P₀, P₁, P₂, . . . . P₁₀. For example, to calculate each minimum area rectangle (for each of the simplified portal splines 320), the relational vector portal system 106 determines a convex hull polygon for the set of points VP. For example, for each simplified portal spline, the relational vector portal system 106 determines a convex hull polygon for the set of points VP for each of the simplified portal splines 320 as the smallest convex boundary that can enclose all of the points (e.g., forming an outer shell around the set of points).

By determining the convex hull polygon, the relational vector portal system 106 reduces the number of edges the relational vector portal system 106 analyzes to determine the bounding box for each of the simplified portal splines 320. To illustrate, the relational vector portal system 106 iteratively rotates the convex hull polygon along each of its edges. In some cases, for each orientation of the convex hull polygon, the relational vector portal system 106 identifies an enclosing rectangle at each orientation. The relational vector portal system 106 selects the minimum area bounding box by selecting the smallest enclosing rectangle. For example, the relational vector portal system 106 utilizes an algorithm such as Algorithm 3 to determine the minimum area bounding boxes 330 for each of the simplified portal splines 320 as follows:

Algorithm 3 Minimum Area Rectangle Detection

| | |
|---|---|
| 1: | procedure MINAREARECTANGLEDETECTION(Vector of Points |

VP)

| | |
|---|---|
| 2: | CHP ← Convex Hull Polygon of set of points VP |
| 3: | MinAreaRect ← ∞ |
| 4: | for every edge E in Convex Hull Polygon CHP do |
| 5: | Θ ← Angle of Edge E |
| 6: | The angle is calculated in anticlockwise direction from positive x |

axis.

| | |
|---|---|
| 7: | RotatedCHP ← ROTATE ConvexHullPolygon CHP by Θ in |

clockwise direction

| | |
|---|---|
| 8: | Rect ← GENERATEENCLOSINGRECTANGLE of the rotated |

ConvexHullPolygon CHP

| | |
|---|---|
| 9: | Track the minimum area rectangle as MinAreaRect among all |

enclosing rectangles

| | |
|---|---|
| 10: | Area ← Area of enclosing rectangle Rect of RotatedCHP |
| 11: | if Area < MinAreaRect then |
| 12: | MinAreaRect ← Area |
| 13: | return MinAreaRect |

To illustrate, as shown by FIG. 3 and described in Algorithm 3, the relational vector portal system 106 determines an enclosing rectangle for each rotation of the convex hull polygon (e.g., as depicted by a rectangle 334a, a rectangle 334b, a rectangle 334c, a rectangle 334d, and a rectangle 334e) for one of the simplified portal splines 320. In turn, the relational vector portal system 106 determines the minimum area bounding boxes 330 by selecting the smallest of the enclosing rectangles for each of the simplified portal splines 320.

In one or more embodiments, the relational vector portal system 106 generates directional flow axes 340 to provide a reference for transforming vector objects through the linked portals 310. As shown in FIG. 3, the relational vector portal system 106 determines the directional flow axes 340 for the simplified portal splines 320 (and linked portals 310 associated with the simplified portal splines 320). In one or more embodiments, the relational vector portal system 106 determines the directional flow axes 340 as the primary directional axes for the simplified portal splines 320 such as described in Algorithm 4 below:

Algorithm 4 Directional Flow Axis Detection

| | |
|---|---|
| 1: | procedure DIRECTIONALFLOWAXISDETECTION |
| 2: | VP ← Vector of Points of path whose axis needs to be detected |
| 3: | MinAreaRect ← MINAREARECTANGLEDETECTION(VP) |
| 4: | MinAreaRect will have two axes passing through its length |

edges.The relational vector portal system can use either of the axes
as a symmetric axis along which reflection of anchor and control
points of path segments will take place.

| | |
|---|---|
| 5: | Axis1, Axis2 ← 2 axes passing through length edges of |

MinAreaRect

| | |
|---|---|
| 6: | AxisC ← Axis1 or Axis2 |
| 7: | Θ ← Inclination Angle of AxisC |
| 8: | Axis ← Generate a line at Θ angle passing through the parallel |

side of MinAreaRect which is closer to the last pen down position.

| | |
|---|---|
| 9: | return Axis |

As described in Algorithm 4, in one or more embodiments, the relational vector portal system 106 determines each of the directional flow axes 340 by selecting a lengthwise axis based on the orientation and inclination of the minimum area bounding boxes 330. As also described, the relational vector portal system 106 determines the directional flow axes 340 as aligned with the general direction of the simplified portal splines 320 starting from the last significant point (e.g., a pen-down position). In certain embodiments, the relational vector portal system 106 utilizes the directional flow axes 340 to apply the transformations for the linked portals 310 as described herein.

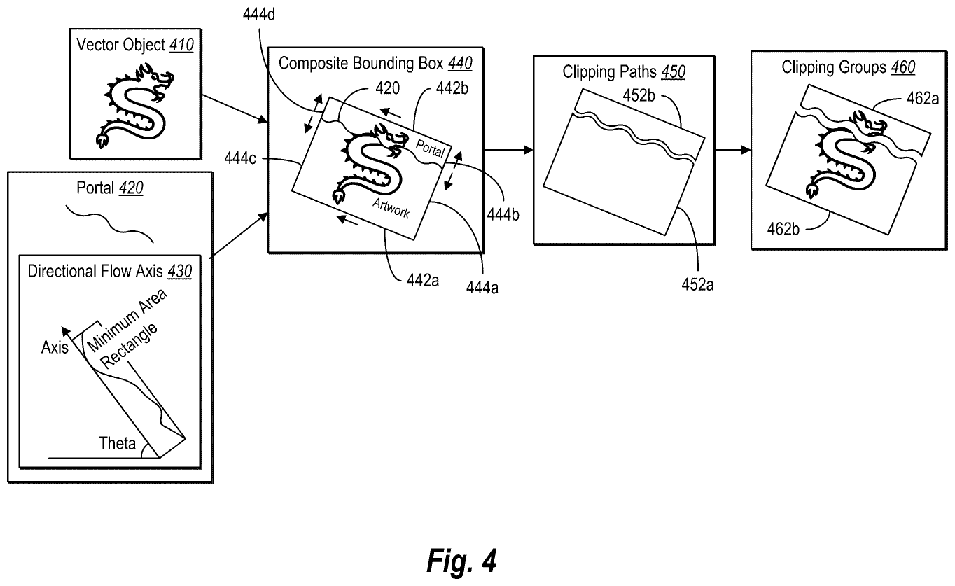

As mentioned, the relational vector portal system 106 transforms a portion of a vector object based on the intersection of the vector object traversing an entry portal with the exit portal. In some embodiments, the relational vector portal system 106 generates clipped vector objects using clipping groups to select portions of the vector object to hide, display, or transform at the relational portals (e.g., the entry portal and/or the exit portal). FIG. 4 illustrates an example of generating clipping groups for a vector object and a portal in accordance with one or more embodiments.

As shown in FIG. 4, the relational vector portal system 106 determines clipping groups 460 from a vector object 410 and a portal 420 utilizing a direction flow axis 430. To illustrate, the relational vector portal system 106 determines a composite bounding box 440 that encompasses both the vector object 410 and the portal 420. In some cases where the direction flow axis 430 for the portal 420 is approximately 0, 90, 180, or 270 degrees, the relational vector portal system 106 determines the composite bounding box 440 by determining the bounds for the vector object 410, determining the bounds for the portal 420, and performing a union of bounds.

In some cases (including cases where the direction flow axis 430 for the portal 420 is not 0, 90, 180, or 270 degrees), the relational vector portal system 106 determines the composite bounding box 440 based on the direction flow axis 430. To illustrate, the relational vector portal system 106 determines the farthest points of the vector object 410 along the normal of the direction flow axis 430. In some cases, the relational vector portal system 106 determines two lines parallel to the direction flow axis 430 at the farthest points of the vector object 410 such that the length of the two lines is equal to (or nearly equal to) the length of the minimum area bounding box for the portal 420. To illustrate, as shown on FIG. 4, the relational vector portal system 106 determines a first farthest point along the normal of the direction flow axis 430 of the portal 420 as the farthest point on the dragon tail and generates a first line 442a parallel to the direction flow axis 430. As also shown, the relational vector portal system 106 determines a second farthest point along the normal of the direction flow axis 430 of the portal 420 as the farthest point on the dragon head and generates a second line 442b parallel to the direction flow axis 430.

In some cases, the relational vector portal system 106 connects the two lines utilizing additional lines generated along both normal from the endpoints of the portal 420. As shown in FIG. 4, the relational vector portal system 106 connects the first line 442a to the portal 420 with a line 444a and a line 444c. As also shown, the relational vector portal system 106 connects the second line 442b to the portal 420 with a line 444b and a line 444d. The relational vector portal system 106 determines the composite bounding box 440 as the box enclosed by the first line 442a, the second line 442b, the line 444a, the line 444b, the line 444c, and the line 444d.

As further shown on FIG. 4, the relational vector portal system 106 determines the clipping paths 450. In one or more embodiments, the relational vector portal system 106 determines the clipping paths 450 utilizing the intersection of the composite bounding box 440 with the portal 420. For example, the relational vector portal system 106 determines the clipping paths 450 as the clipping path 452a and clipping path 452b by applying Boolean divide operation between the composite bounding box 440 and the portal 420.

As also shown in FIG. 4, in one or more embodiments, the relational vector portal system 106 determines clipping groups 460 for the intersection of the vector object 410 with the portal 420. As shown, relational vector portal system 106 divides the vector object 410 into a pre-intersection object portion that precedes the entry portal and the post-intersection object portion that succeeds the entry portal along the intersection path of the vector object with the portal 420. In one or more embodiments, a pre-intersection object portion includes or refers to a portion of a vector object that precedes the intersection of the vector object 410 with a defined boundary, such as the portal 420. In some cases, the pre-intersection object portion includes a portion of the vector object 410 positioned to one side of the portal 420. In one or more embodiments, a post-intersection object portion includes or refers to a portion of a vector object that succeeds the intersection of the vector object 410 with a defined boundary, such as the portal 420. In some cases, the pre-intersection object portion includes a portion of the vector object 410 positioned on the opposite side of the portal 420 from the pre-intersection object portion.

In some embodiments, the relational vector portal system 106 determines the clipping groups 460 such that the vector object 410 is visible along the +90 degree angle from the direction flow axis 430 for exit portals (e.g., post-intersection object portion) and the vector object 410 is visible along the −90 degree angle from the direction flow axis 430 for entry portals (e.g., pre-intersection object portion). Furthermore, in some cases, the relational vector portal system 106 flips the orientation/direction of the portal 420 to determine the clipping groups 460 such that the vector object 410 is visible along the −90 degree angle from the direction flow axis 430 for exit portals and the vector object 410 is visible along the +90 degree angle from the direction flow axis 430 for entry portals.

To elaborate, as shown in FIG. 4, the relational vector portal system 106 generates the clipping groups 460 utilizing the clipping paths 450 based on an intersection path of the vector object 410 with the portal 420.

In one or more embodiments, the relational vector portal system 106 determines the clipping groups 460 utilizing the clipping paths 450 associated with the portal 420 (e.g., the entry portal and/or the exit portal) and the vector object 410. For example, the relational vector portal system 106 generates the clipping groups 460 by including one of the clipping paths 450 that defines the visible area (e.g., clipping path 452a, clipping path 452b) as well as a portion of the vector object 410 (e.g., pre-intersection object portion, post-intersection object portion). To illustrate, to determine the clipping group 462a associated with an exit portal, the relational vector portal system 106 selects a test point +90 degrees along the normal from an approximate center of the portal 420 with a fixed distance such that it is outside the boundary for the portal 420 (e.g., extends past the stroke width of the portal spline). In certain embodiments, the relational vector portal system 106 performs hit testing to select from the clipping groups 460 to associate the clipping group 462a that contains the test point for the exit portal with the portal 420 and discard the clipping group 462b that does not contain the test point.

Similarly, in certain embodiments, to determine the clipping group 462a associated with an entry portal, the relational vector portal system 106 selects a test point −90 degrees along the normal from the approximate center of the portal 420 with a fixed distance such that it is outside the boundary for the portal 420. In certain embodiments, the relational vector portal system 106 performs hit testing to select from the clipping groups 460 to associate the clipping group 462b that contains the test point for the entry portal with the portal 420 and discard the clipping group 462a that does not contain the test point.

The relational vector portal system 106 employs the technique illustrated in FIG. 4 for each portal 420 in a vector image (e.g., entry portals, exit portals). In this way, the relational vector portal system 106 adjusts for differences in the shapes of the vector paths associated with each portal 420 in a vector image. For example, for each portal within a vector image (e.g., the portal 420), the relational vector portal system 106 generates the clipping groups 460 and renders the transformed vector objects adjusted to the portal 420.

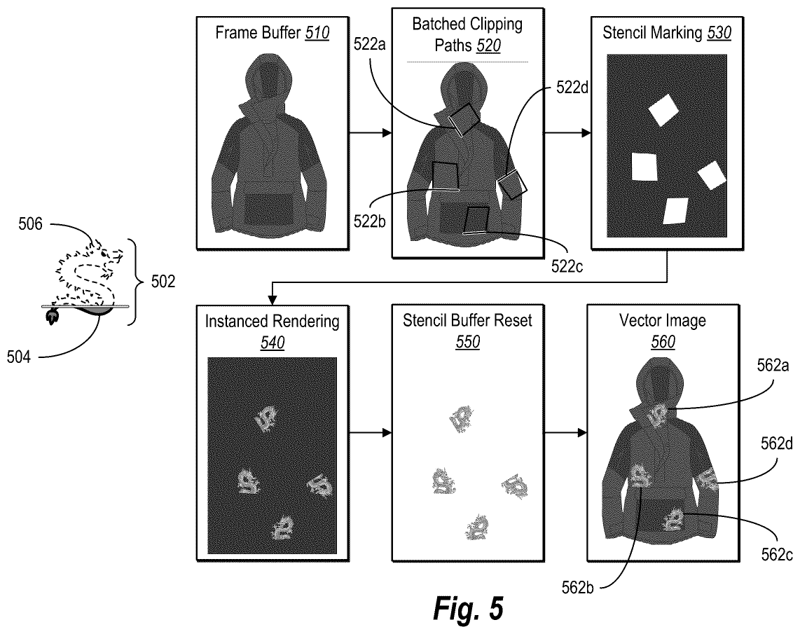

As mentioned, the relational vector portal system 106 generates an entry portal such that a vector object traversing the entry portal becomes invisible upon crossing the entry portal and reappears at a linked exit portal. In some cases, the relational vector portal system 106 generates multiple exit portals linked to the entry portal, such that multiple copies of the portion of the vector object that vanishes upon transversing the entry portal emerge at multiple linked exit portals. FIG. 5 illustrates an example of utilizing optimized rendering to display multiple transformed vector objects utilizing the relational vector portal system in accordance with one or more embodiments.

As shown in FIG. 5, in some cases the relational vector portal system 106 duplicates a post-intersection object portion 506 of a vector object 502 at multiple exit portals to render a vector image 560. As described, the relational vector portal system 106 determines the post-intersection object portion 506 for the vector object 502 based on an intersection of the vector object 502 with entry portal 504 as it traverses the entry portal 504. In addition, the relational vector portal system 106 renders a transformed vector object 562a by positioning a copy of the post-intersection object portion 506 at exit portal 522a which is linked to the entry portal 504. Similarly, the relational vector portal system 106 renders a transformed vector object 562b by positioning a copy of the post-intersection object portion 506 at exit portal 522b, renders a transformed vector object 562c by positioning a copy of the post-intersection object portion 506 at exit portal 522c, and renders a transformed vector object 562d by positioning a copy of the post-intersection object portion 506 at exit portal 522d. In some cases, the relational vector portal system 106 performs independent transformations on each of the transformed vector object 562a, the transformed vector object 562b, the transformed vector object 562c, and the transformed vector object 562d (e.g., spatial transformation, style transformation, and/or scale transformation).

In one or more embodiments, the relational vector portal system 106 utilizes optimized rendering techniques when generating the duplicates of the post-intersection object portion 506 for the exit portal 522a, the exit portal 522b, the exit portal 522c, and the exit portal 522d. For example, the relational vector portal system 106 utilizes instancing to render the duplicates of the post-intersection object portions 506 at once with a single render call. In this way, the relational vector portal system 106 utilizes a single CPU-GPU communication to render the duplicates of the post-intersection object portions 506 (e.g., the transformed vector object 562a, the transformed vector object 562b, the transformed vector object 562c, and the transformed vector object 562d).

To illustrate, the relational vector portal system 106 utilizes a frame buffer 510 to store vector image data for display on a client device. In one or more embodiments, the frame buffer 510 includes or refers to a structured space for the relational vector portal system 106 to assemble and manage vector objects. For example, the relational vector portal system 106 utilizes the frame buffer 510 as a canvas to collect rendering output before display on the vector image 560.

In some embodiments, the relational vector portal system 106 uses batched clipping paths 520 associated with the exit portals. For example, the relational vector portal system 106 utilizes the batched clipping paths 520 to define the areas for rendering the duplicates of the post-intersection object portions 506 at the exit portal 522a, the exit portal 522b, the exit portal 522c, and the exit portal 522d. The relational vector portal system 106 utilizes batching to combine the drawing calls for the duplicates of the post-intersection object portion 506 into the batched clipping paths 520. In some cases, the relational vector portal system 106 generates the batched clipping paths 520 as simple closed path vector objects in a single GPU draw call.

In some embodiments, the relational vector portal system 106 performs stencil marking 530. For example, the relational vector portal system 106 uses a specialized buffer within the frame buffer 510 to control which areas of the vector image 560 are affected by rendering the duplicates of the post-intersection object portions 506. As shown, the relational vector portal system 106 utilizes stencil marking 530 to mark the clipping paths of each exit portal. For example, the relational vector portal system 106 utilizes the stencil marking 530 to limit the designated areas for rendering the duplicates of the post-intersection object portions 506 to the clipping paths of each exit portal.

As also shown, the relational vector portal system 106 performs an instanced rendering 540. As mentioned, the relational vector portal system 106 utilizes the instanced rendering 540 to render the duplicates of the post-intersection object portions 506 multiple times with a single render call. For example, the relational vector portal system 106 utilizes the instanced rendering 540 to render the duplicates of the post-intersection object portions 506 multiple times with a single render call, while applying different transformations (e.g., position, scale, style) for each instance. In some cases, the relational vector portal system 106 performs the instanced rendering 540 by providing an extra parameter (e.g., instance count parameter) to the instanced versions of the rendering functions to set the number of instances to render. In some embodiments, the relational vector portal system 106 sets the number of instances equal to the number of exit portals. In addition to an instance count, in some cases, the relational vector portal system 106 utilizes the Affine transformation Matrix shown below to position the duplicates of the post-intersection object portions 506 at the respective exit portals as follows:

$$A = ( \begin{matrix}{a}_{11} & {a}_{12} & {t}_{x} \\ {a}_{21} & {a}_{22} & {t}_{y} \\ 0 & 0 & 1\end{matrix} )$$

For example, the relational vector portal system 106 utilizes aᵢ to represent scaling, rotation, and shearing and tᵢ to denote translation components along direction i.

As shown in FIG. 5, in addition to performing the instanced rendering 540, the relational vector portal system 106 performs a stencil buffer reset 550. For example, the relational vector portal system 106 clears any stencil bits from the stencil buffer to remove the markings for the clipping paths. In some cases, the relational vector portal system 106 performs the stencil buffer reset 550 to remove residual markings and/or unintended artifacts from the stencil buffer.

In one or more embodiments, the relational vector portal system 106 displays the vector image 560. For example, the relational vector portal system 106 displays (or provides for display) a fully rendered vector image for the vector image 560 containing the multiple instances of the duplicates of the post-intersection object portion 506 positioned correctly at each exit portal. In some cases, the relational vector portal system 106 displays the vector image as it appears in the frame buffer 510 after the clipping and transformations have been applied as described in relation to FIG. 5.

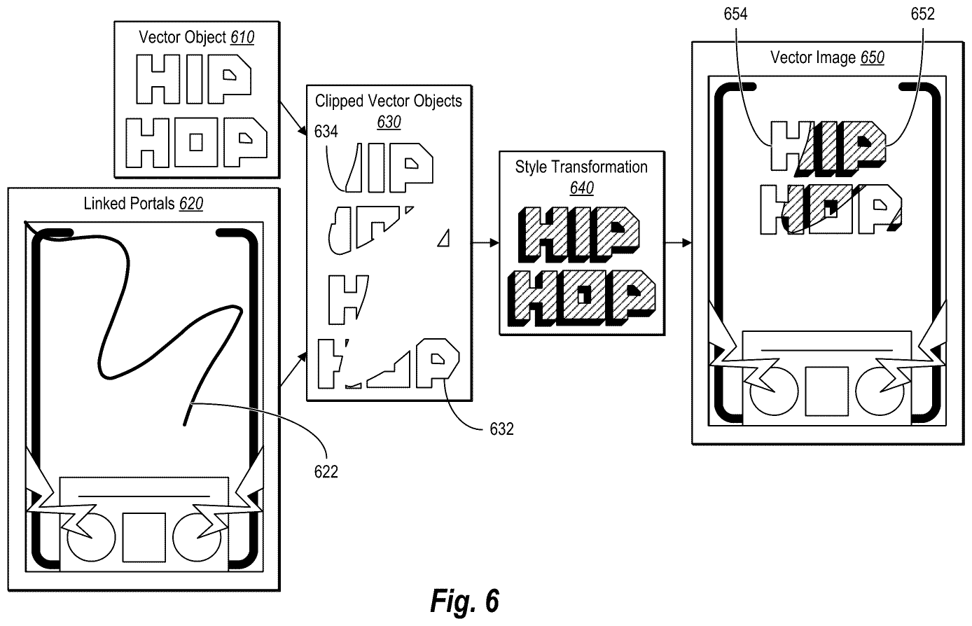

As mentioned, in one or more embodiments, the relational vector portal system 106 performs one or more types of transformations on the post-intersection object portion of a vector object. FIG. 6 illustrates an example of generating a transformed vector object utilizing a bidirectional portal to apply a style transformation in accordance with one or more embodiments.

As shown in FIG. 6, the relational vector portal system 106 generates a vector image 650 from a vector object 610 utilizing linked portals 620. As shown, the relational vector portal system 106 utilizes a bidirectional portal 622 for the linked portals 620. For example, the bidirectional portal 622 includes or refers to a standalone portal represented by a vector path that is marked as both an entry portal and an exit portal. To elaborate, once a vector object 610 passes through one side of the bidirectional portal 622 (e.g., the entry portal), the post-intersection object portion emerges from the other side of the bidirectional portal 622 (e.g., the exit portal). In some cases, the relational vector portal system 106 generates the bidirectional portal 622 by aligning the entry portal with the first side of a vector path and aligning the exit portal with the second (or opposite) side of the vector path.

As shown in FIG. 6, the relational vector portal system 106 generates clipped vector objects 630 based on the intersection of the vector object 610 with the bidirectional portal 622. For example, the relational vector portal system 106 utilizes clipping groups to divide the vector object 610 into the clipped vector objects 630. In particular, the relational vector portal system 106 divides the vector object 610 into a pre-intersection object portion 632 that precedes the entry portal of the bidirectional portal 622 and a post-intersection object portion 634 that succeeds the entry portal of the bidirectional portal 622. As shown, the pre-intersection object portion 632 and the post-intersection object portion 634 are divided along the intersection path of the bidirectional portal 622 into separate clipped vector objects.

In certain embodiments, the relational vector portal system 106 applies a style transformation 640 to generate a transformed vector object 652 by altering the appearance of a copy of the post-intersection object portion 634. For example, the relational vector portal system 106 applies one or more stylized appearances (e.g., fill strokes, dynamic effects) of a graphic style associated with the exit portal of the bidirectional portal 622 to the post-intersection object portion 634. In some cases, the relational vector portal system 106 applies the style transformation 640 as a post-operation transmutation by applying a stored graphic style associated with the exit portal of the bidirectional portal 622 to the post-intersection object portion 634.

In one or more embodiments, the relational vector portal system 106 provides, for display on a graphical user interface, the vector image 650. As shown, the relational vector portal system 106 provides the vector image 650 which includes the pre-intersection object portion 654 and the transformed vector object 652. As shown, the relational vector portal system 106 creates a visual appearance showing that when the vector object 610 passes through one side of the bidirectional portal 622, it emerges from the other side as a continuous vector object with two different styles. As mentioned, the relational vector portal system 106 automatically provides real-time updates to the pre-intersection object portion 654 and the transformed vector object 652 based on changes to the vector object 610 (e.g., movement, modification) or changes to the bidirectional portal 622.

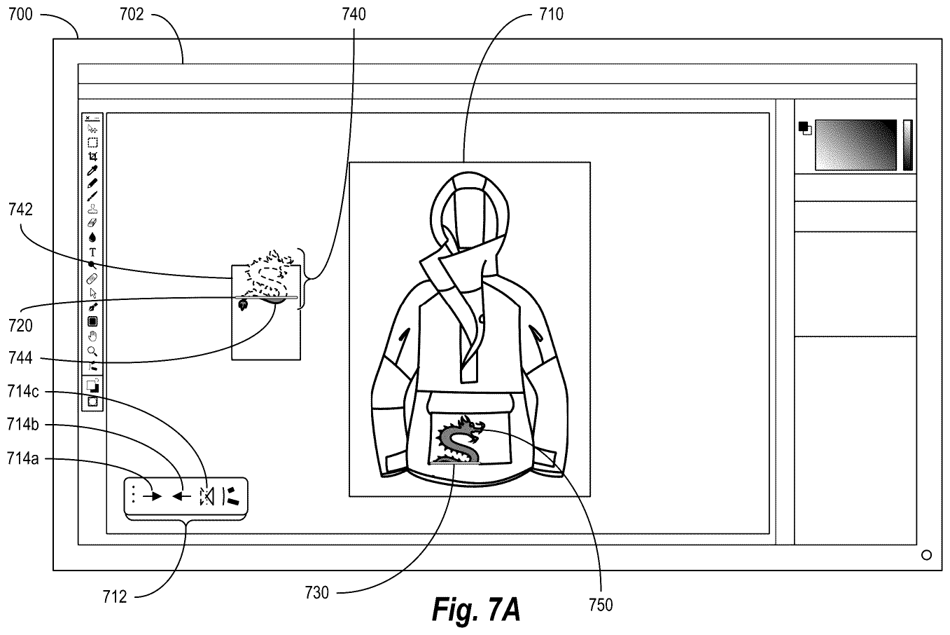

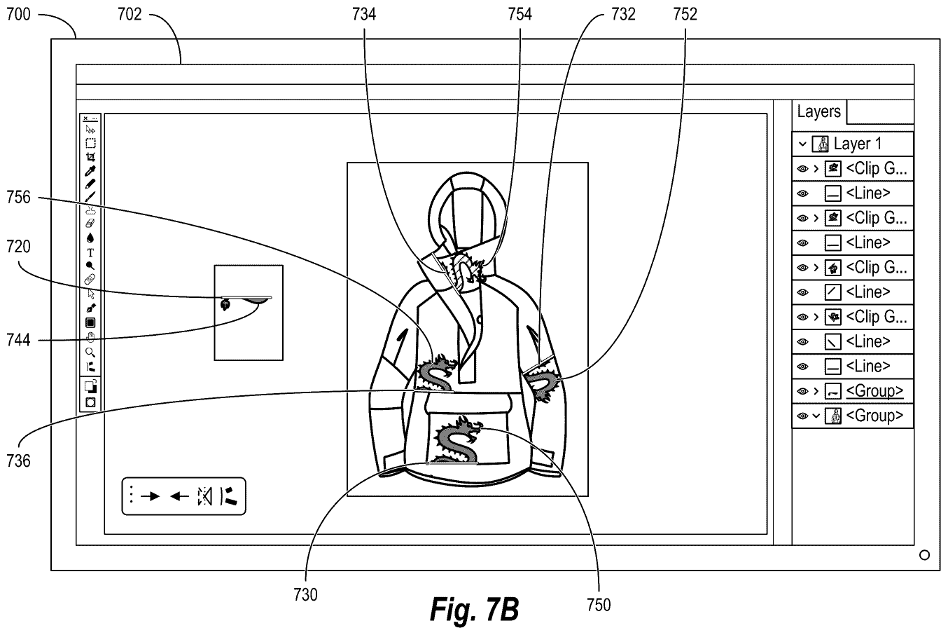

The relational vector portal system 106 flexibly and efficiently transforms a portion of a vector object as described above in response to a user device interaction moving a vector object to traverse, or intersect with, an entry portal. In certain embodiments, the relational vector portal system 106 utilizes a combination of one or more of the methods described above to transform vector objects. FIGS. 7A-10B illustrate various examples of interacting with relational portals to perform transformations on vector objects.

For instance, FIGS. 7A-7B illustrate examples of performing spatial transformations on a vector object 740. As shown in FIG. 7A, the relational vector portal system 106 provides a graphical user interface 702 for display on a client device 700. In particular, the relational vector portal system 106 provides the graphical user interface 702 to utilize relational portals to modify vector objects associated with the vector image 710. In some cases, the relational vector portal system 106 provides a portal interface 712 that includes an entry portal selection item 714a to select entry portals, an exit portal selection item 714b to select exit portals, and a portal orientation item 714c to flip the orientation of portals.

In one or more embodiments, based on a user interaction with the graphical user interface 702, the relational vector portal system 106 generates or assigns an entry portal 720 associated with a vector path. In some cases, based on user interactions selecting a vector path and interacting with the entry portal selection item 714a, the relational vector portal system 106 assigns the entry portal 720 to align with the vector path on the graphical user interface 702. As shown, based on a user interaction with the graphical user interface 702, the relational vector portal system 106 moves the vector object 740 (e.g., dragon vector object) to traverse the entry portal 720. In certain embodiments, the relational vector portal system 106 causes the post-intersection object portion 742 to be removed from display while retaining the pre-intersection object portion 744 for display. In some cases, the relational vector portal system 106 causes the appearance of the post-intersection object portion 742 to change (e.g., an opacity change) while retaining the appearance of the pre-intersection object portion 744 on the graphical user interface 702.

As also shown in FIG. 7A, based on a user interaction with the graphical user interface 702, the relational vector portal system 106 generates or assigns an exit portal 730. For example, based on user interactions selecting a vector path and interacting with the exit portal selection item 714b, the relational vector portal system 106 assigns the exit portal 730. As shown, the relational vector portal system 106 generates the exit portal 730 aligned with a vector path at a second position (e.g., the position is different than the position of the entry portal). Furthermore, the relational vector portal system 106 generates the exit portal 730 as a relational portal linked to the entry portal 720 such that a transformed vector object 750 emerges from the exit portal 730 (by transforming a copy of the post-intersection object portion 742).

To elaborate, as the vector object 740 traverses the entry portal 720 the relational vector portal system 106 gradually removes the portion of the vector object 740 that crosses the intersecting path of the entry portal 720 (e.g., the post-intersection object portion 742) and displays the transformed vector object 750 as emerging from the exit portal 730. In particular, the relational vector portal system 106 continuously updates the clipped vector objects of the post-intersection object portion 742 and the pre-intersection object portion 744 as the vector object 740 traverses the entry portal 720. Additionally, the relational vector portal system 106 continuously updates the graphical user interface 702 to remove the post-intersection object portion 742 from display and provide the transformed vector object 750 for display.

FIG. 7B illustrates an example of performing multiple spatial transformations on the vector object 740 utilizing a one-to-many relationship between the entry portal 720 and multiple exit portals in accordance with one or more embodiments. For example, as shown in FIG. 7B and based on user interactions selecting multiple vector paths and interacting with the exit portal selection item 714b, the relational vector portal system 106 generates the exit portal 730, an exit portal 732, an exit portal 734, and an exit portal 736. As shown, the relational vector portal system 106 generates the exit portal 730, the exit portal 732, the exit portal 734, and the exit portal 736 aligned with multiple vector paths. Furthermore, the relational vector portal system 106 generates the exit portal 730, the exit portal 732, the exit portal 734, and the exit portal 736 as relational portals linked to the entry portal 720 in a one-to-many relationship. As shown, the relational vector portal system 106 renders a transformed vector object 750 by positioning a copy of the post-intersection object portion 742 to emerge from the exit portal 730, renders a transformed vector object 752 by positioning a copy of the post-intersection object portion 742 to emerge from the exit portal 732, renders a transformed vector object 754 by positioning a copy of the post-intersection object portion 742 to emerge from the exit portal 734, and renders a transformed vector object 756 by positioning a copy of the post-intersection object portion 742 to emerge from the exit portal 736. For example, the relational vector portal system 106 renders the transformed vector object 750, the transformed vector object 752, the transformed vector object 754, and the transformed vector object 756 utilizing instanced rendering and spatial transformations such as described in relation to FIG. 5.

As also illustrated by FIG. 7B, the relational vector portal system 106 provides the transformed vector object 750, the transformed vector object 752, the transformed vector object 754, and the transformed vector object 756 utilizing individualized transformations associated with the associated exit portals (e.g., the exit portal 730, the exit portal 732, the exit portal 734, and the exit portal 736). For example, the relational vector portal system 106 displays the transformed vector object 750 by transforming the size (e.g., increasing) of a copy of the post-intersection object portion 742. As shown, the relational vector portal system 106 displays the transformed vector object 754 by transforming the style (e.g., shading) of a copy of the post-intersection object portion 742. Furthermore, the relational vector portal system 106 displays the transformed vector object 752 by transforming the orientation (e.g., flipping) of a copy of the post-intersection object portion 742.

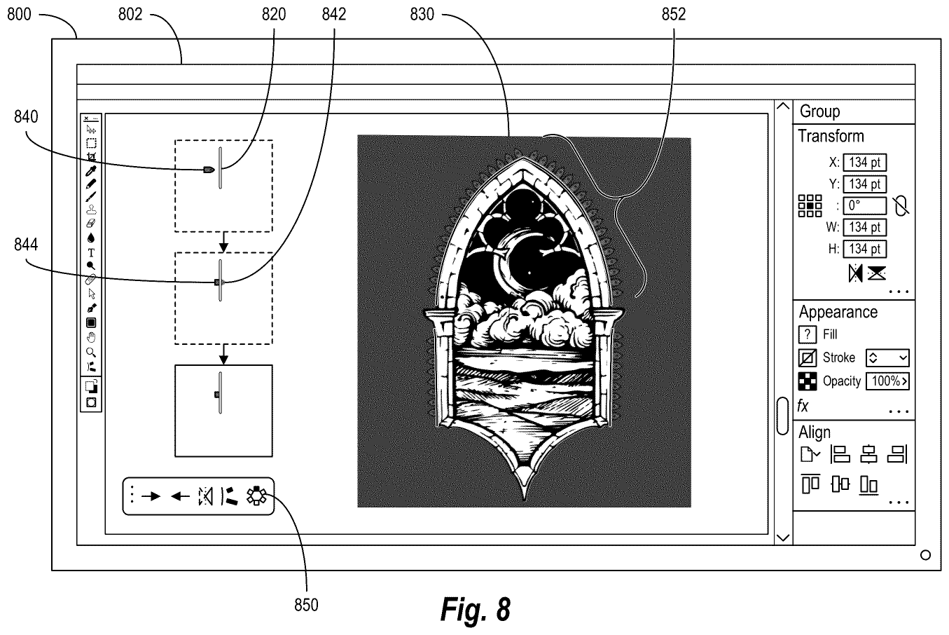

In certain embodiments, the relational vector portal system 106 provides additional options to transform a vector object using a one-to-many relationship. To illustrate, FIG. 8 illustrates an example of rendering multiple transformed vector objects utilizing a one-to-many relationship between an entry portal 820 and an exit portal 830 in accordance with one or more embodiments.

As shown in FIG. 8, based on a user interaction with a graphical user interface 802 on a client device 800, the relational vector portal system 106 causes the vector object 840 to traverse the entry portal 820 and divides the vector object 840 into a pre-intersection object portion 844 and a post-intersection object portion 842. For example, the relational vector portal system 106 continuously monitors the traversal of the vector object 840 with the entry portal 820 to generate pre-intersection object portion 844 and a post-intersection object portion 842 utilizing clipping paths.

As also shown, based on a user interaction with a duplication selection item 850, the relational vector portal system 106 generates an exit portal 830 linked to the entry portal 820. In turn, the relational vector portal system 106 generates the transformed vector objects 852 as duplicate copies of the post-intersection object portion 842 combined for display at the exit portal 830. In certain embodiments, the relational vector portal system 106 determines a number of the duplicate copies of the post-intersection object portion 842 to combine for display at the exit portal 830 based on a comparison of the size of the post-intersection object portion 842 and the size of the exit portal 830. In some embodiments, based on the transformation associated with the exit portal 830, the relational vector portal system 106 generates multiple copies of the of the post-intersection object portion 842 utilizing instanced rendering and spatial transformations such as described in relation to FIG. 5.

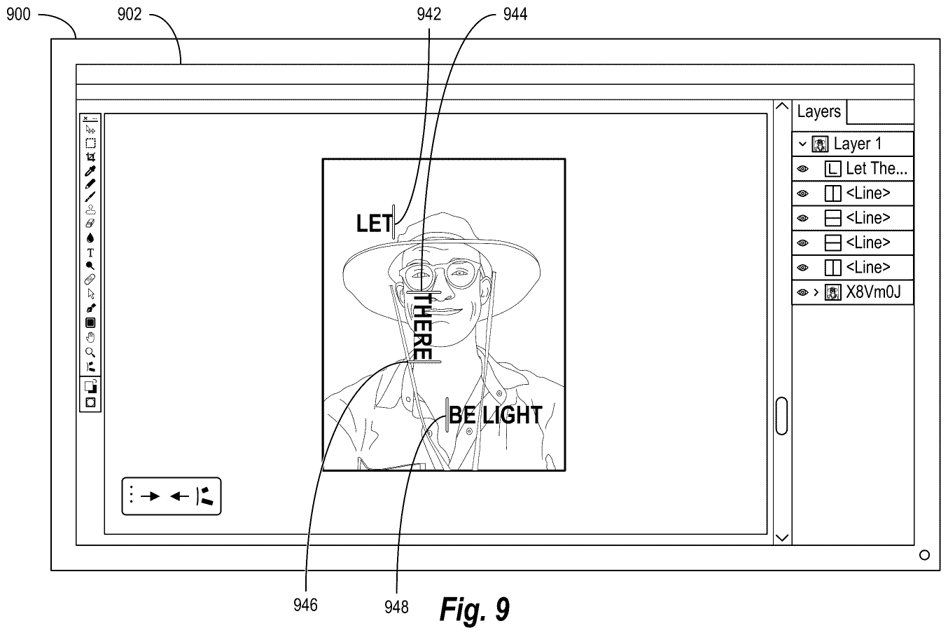

In certain embodiments, the relational vector portal system 106 portals can be utilized sequentially. FIG. 9 illustrates an example of rendering transformed vector objects utilizing multiple sequential entry and exit portals with the relational vector portal system in accordance with one or more embodiments. For example, FIG. 9 shows an entry portal 942, an exit portal 944, an entry portal 946, and an exit portal 948 positioned sequentially (e.g., adjacent), in alternating orientations. As shown, the textual vector content of “LET THERE BE LIGHT” traverses the entry portal 942 to emerge from the exit portal 944. Furthermore, the textual vector content is long enough that part of the vector content also traverses the entry portal 946 to emerge from the exit portal 948. Notably, the relational vector portal system 106 performs multiple transformations on the textual vector content of “LET THERE BE LIGHT.”

To illustrate, based on a user interaction with a graphical user interface 902 on a client device 900, the relational vector portal system 106 causes textual vector content of “LET THERE BE LIGHT” to traverse a sequence of relational portals. For example, the relational vector portal system 106 performs a first transformation (a first spatial transformation in combination with a first orientation transformation and a first style transformation) on the textual vector content of “LET THERE BE LIGHT” to cause the first post-intersection portion of “THERE BE LIGHT” that traverses the entry portal 942 to emerge from the exit portal 944. Furthermore, the relational vector portal system 106 performs a second transformation (a second spatial transformation in combination with a second orientation transformation and a second style transformation) on the second post-intersection portion of “BE LIGHT” that traverses the entry portal 946 to emerge from the exit portal 948. In some embodiments, the relational vector portal system 106 performs the second transformation by modifying the first transformation for the second post-intersection portion. In some embodiments, the relational vector portal system 106 performs the second transformation by replacing the first transformation for the second post-intersection portion.

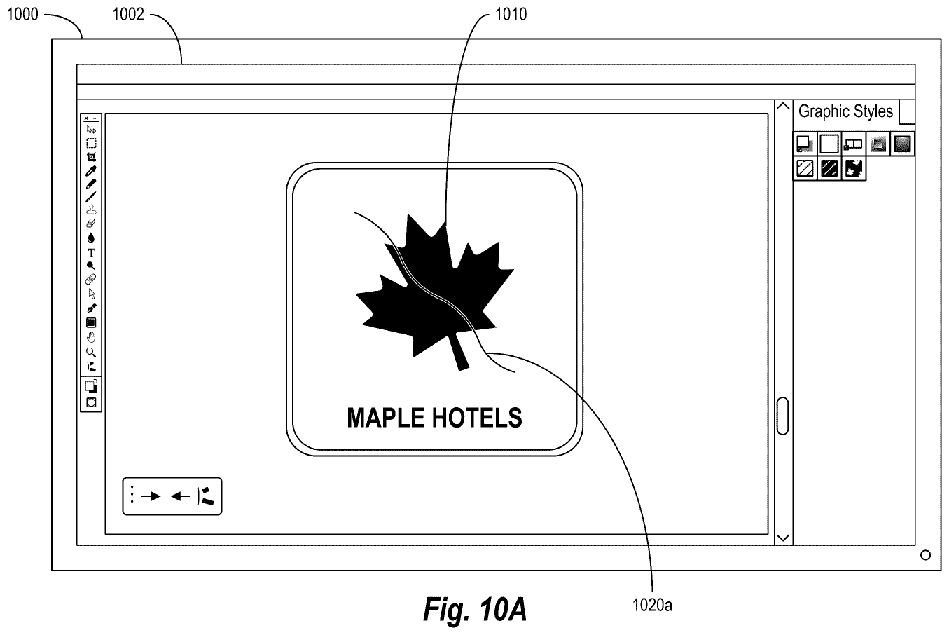

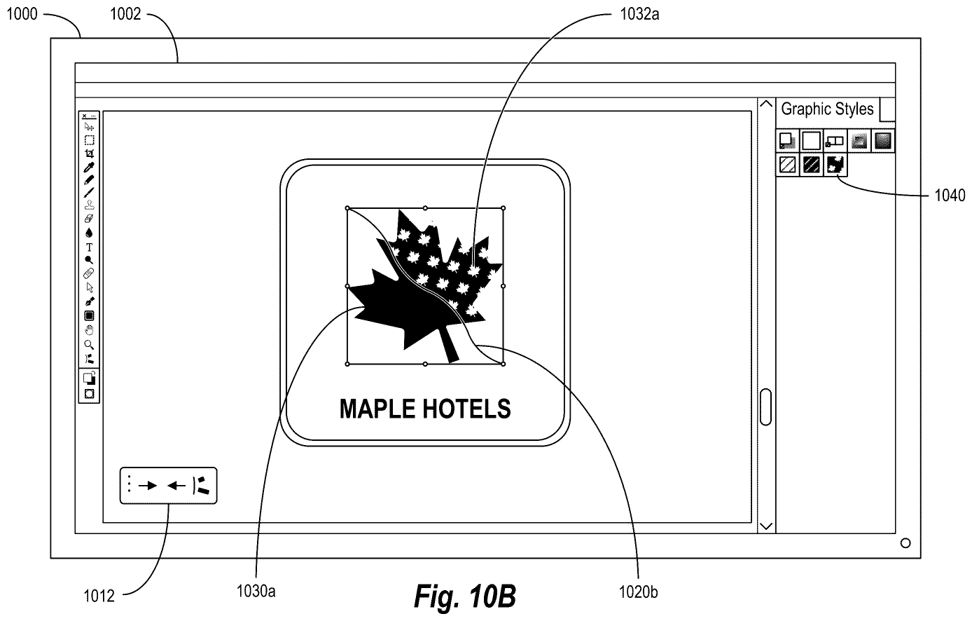

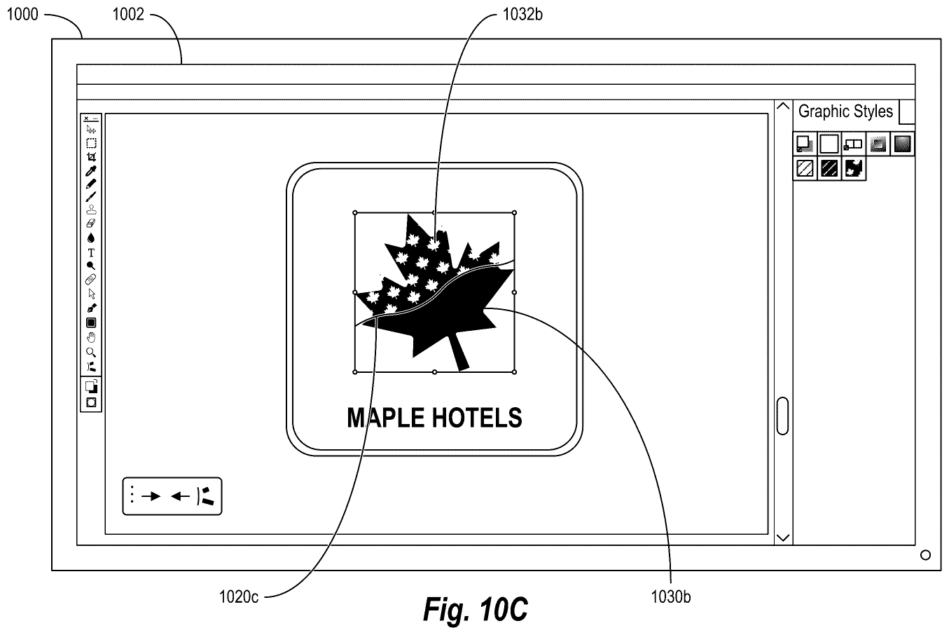

As described, embodiments of the relational vector portal system 106 generate transformations for vector objects using bidirectional portals. FIGS. 10A-10C illustrate examples of rendering a transformed vector object by changing an appearance style using a bidirectional portal in accordance with one or more embodiments.

As shown in FIG. 10A, the relational vector portal system 106 provides a graphical user interface 1002 for display on a client device 1000 for generating transformed vector objects utilizing relational portals. As shown, the graphical user interface 1002 provides a vector object 1010 (e.g., leaf vector object) and a vector path 1020a for display.

As shown in FIG. 10B, based on a user interaction with a portal interface 1012, the relational vector portal system 106 generates a bidirectional portal 1020b aligned with the vector path 1020a (e.g., an entry portal and a linked exit portal). In particular, the relational vector portal system 106 aligns the entry portal of the bidirectional portal 1020b with a first side of the vector path 1020a and aligns the exit portal of the bidirectional portal 1020b with a second (opposite) side of the vector path 1020a. In addition, based on a user interaction selecting the graphic style 1040, the relational vector portal system 106 associates the graphic style 1040 with the exit portal of the bidirectional portal 1020b.

Based on the intersection of the vector object 1010 with the bidirectional portal 1020b, the relational vector portal system 106 generates a pre-intersection object portion 1030a and a post-intersection object portion. As shown, the relational vector portal system 106 maintains the appearance of the pre-intersection object portion 1030a and removes the post-intersection object portion from display. Furthermore, the relational vector portal system 106 generates a transformed vector object 1032a by: (a) positioning a copy of the post-intersection object portion at the exit portal of the bidirectional portal 1020b (e.g., a spatial transformation) and (b) performing a style transformation to alter the style of the copy of the post-intersection object portion to the graphic style 1040 associated with the exit portal of the bidirectional portal 1020c.

As shown, by utilizing the bidirectional portal 1020b, the relational vector portal system 106 displays the vector object 1010 using two separate styles. To elaborate, the relational vector portal system 106 displays the pre-intersection object portion 1030a and the transformed vector object 1032a on either side of the bidirectional portal 1020b causing the appearance of a continuous object with multiple styles. In one or more embodiments, the relational vector portal system 106 can utilize the bidirectional portal 1020b to render the transformed vector object 1032a using a variety of transformations such as scale, skew, opacity, rotation, or perspective.

As further shown in FIG. 10C, in certain embodiments, the relational vector portal system 106 continuously updates the display of the pre-intersection object portion 1030a and the transformed vector object 1032a. For example, as shown in FIG. 10C, the bidirectional portal 1020b is rotated to a new position as shown by bidirectional portal 1020b. As described in relation to FIG. 10B, based on an intersection of the vector object 1010 with the bidirectional portal 1020c, the relational vector portal system 106 generates a pre-intersection object portion 1030b and a post-intersection object portion. As shown, the relational vector portal system 106 maintains the appearance of the pre-intersection object portion 1030b and removes the post-intersection object portion from display. Furthermore, the relational vector portal system 106 generates a transformed vector object 1032b by: (a) positioning a copy of the post-intersection object portion at the exit portal of the bidirectional portal 1020c (e.g., a spatial transformation) and (b) performing a style transformation to alter the style of the copy of the post-intersection object portion to the graphic style 1040 associated with the exit portal of the bidirectional portal 1020c.

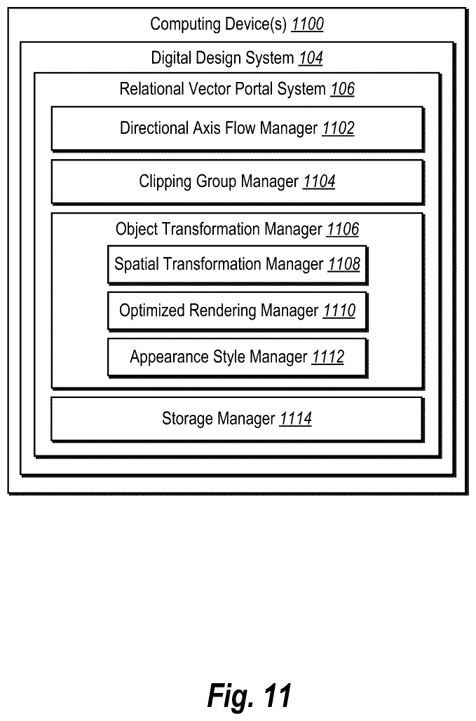

Turning now to FIG. 11, additional detail will now be provided regarding various components and capabilities of the relational vector portal system 106. In particular, FIG. 11 illustrates the relational vector portal system 106 implemented by the computing device 1100 (e.g., the server device(s) 102 and/or one of the client device(s) 110 discussed above with reference to FIG. 1). Additionally, the relational vector portal system 106 is also part of the digital content management system 104. As shown in FIG. 11, the relational vector portal system 106 includes, but is not limited to, a directional axis flow manager 1102, a clipping group manager 1104, an object transformation manager 1106, and a data storage manager 1114.

As just mentioned, and as illustrated in FIG. 11, the relational vector portal system 106 includes the directional axis flow manager 1102. In one or more embodiments, the directional axis flow manager 1102 manages the determination of directional flow of the relational portals. In some embodiments, the directional axis flow manager 1102 determines the directional flow to aid in smart clipping using clipping groups. For example, the directional axis flow manager 1102 determines directional flow axes for portal splines aligned with, or representing, the relational portals. In some cases, the directional axis flow manager 1102 reduces the portal splines into line primitives (e.g., polylines) and determines minimum area bounding boxes for the polylines. Using the minimum area bounding boxes, in some embodiments, the directional axis flow manager 1102 determines directional flow axes for the polylines (and the associated relational portals).

As further shown in FIG. 11, the relational vector portal system 106 includes the clipping group manager 1104. In one or more embodiments, the clipping group manager 1104 manages the determination of clipping groups for portions of a vector object that intersects with an entry portal. In particular, the clipping group manager 1104. In one or more embodiments, the clipping group manager 1104 determines a composite bounding box from a union of the bounds for the vector object and the bounds for the entry portal. In some cases, the clipping group manager 1104 divides the bounding box at the intersection of the bounding box and the entry portal to determine a pre-intersection clipping group incorporating the pre-intersection object portion that precedes the entry portal and the associated clipping path. In some cases, the clipping group manager 1104 divides the bounding box at the intersection of the bounding box and the entry portal to determine a post-intersection clipping group incorporating the post-intersection object portion that has crossed the exit portal and the associated clipping path.

As also shown in FIG. 11, the relational vector portal system 106 utilizes the object transformation manager 1106 to manage spatial and/or style transformations on vector objects that transverse the relational portals. For example, the object transformation manager 1106 transforms a copy of a post-intersection object portion of a vector object that traverses an entry portal at the exit portal by altering one or more of a position, orientation, scale, or style of the copy of the post-intersection object portion.

In one or more embodiments, the object transformation manager 1106 utilizes a spatial transformation manager 1108. For example, the object transformation manager 1106 generates an entry portal such that a vector object traversing the entry portal gradually becomes invisible upon crossing the entry portal. In some embodiments, the object transformation manager 1106 generates an exit portal linked to the entry portal, such that a copy of the portion of the vector object that vanishes upon traversing the entry portal emerges from the exit portal. In some cases, the object transformation manager 1106 generates multiple exit portals linked to the entry portal, such that copies of the portion of the vector object that vanishes upon transversing the entry portal emerges at all of the linked exit portals. In certain cases, the object transformation manager 1106 generates a bidirectional portal where an entry portal and an exit portal are aligned with opposite sides of the same vector path.

In one or more embodiments, the object transformation manager 1106 utilizes an optimized rendering manager 1110. In some embodiments, the optimized rendering manager 1110 manages optimized rendering techniques such as batching and instanced rendering to render the multiple copies of a post-intersection vector object in a single render call. For example, the optimized rendering manager 1110 manages a one-to-many relationship between one entry portal and multiple exit portals. For example, the optimized rendering manager 1110 utilizes a one-to-many correlation between an entry portal and multiple exit portals, to render multiple copies of the post-intersection object portion at multiple linked exit portals. In some cases, the optimized rendering manager 1110 manages the display of multiple copies of a post-intersection object portion at one exit portal.

In one or more embodiments, the object transformation manager 1106 utilizes an appearance style manager 1112. In some embodiments, the appearance style manager 1112 manages stylistic transformations for copies of the post-intersection object portions of vector objects. For example, the appearance style manager 1112 utilizes a post-operation transmutation to apply a graphic style on a copy of post-intersection object portion associated with an exit portal. In some embodiments, the appearance style manager 1112 utilizes a bidirectional portal to create the visual impression of a single object which changes styles at the path intersection of the bidirectional portal. In some embodiments, the appearance style manager 1112 applies a stylistic transformation to the copy of the post-intersection object portion for relational portals where the entry portal is located at a different location than the exit portal.

Additionally, as shown, the relational vector portal system 106 includes the data storage manager 1114. In particular, the data storage manager 1114 (implemented by one or more memory devices) stores the digital summaries and digital documents, including the coreference resolved digital summaries and the coreference resolved digital documents. The data storage manager 1114 facilitates the use of the digital documents by the relational vector portal system 106.

Each of the components 1102-1114 of the relational vector portal system 106 includes software, hardware, or both. For example, the components 1102-1114 include one or more instructions stored on a computer-readable storage medium and executable by processors of one or more computing devices, such as a client device or server device. When executed by the one or more processors, the computer-executable instructions of the relational vector portal system 106 causes the computing device(s) to perform the methods described herein. Alternatively, the components 1102-1114 include hardware, such as a special-purpose processing device to perform a certain function or group of functions. Alternatively, the components 1102-1114 of the relational vector portal system 106 include a combination of computer-executable instructions and hardware.

Furthermore, the components 1102-1114 of the relational vector portal system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1102-1114 of the relational vector portal system 106 are implemented as a stand-alone application, such as a desktop or mobile application. Furthermore, in some embodiments, the components 1102-1114 of the relational vector portal system 106 are implemented as one or more web-based applications hosted on a remote server. Alternatively, or additionally, the components 1102-1114 of the relational vector portal system 106 are implemented in a suite of mobile device applications or “apps.” For example, in one or more embodiments, the relational vector portal system 106 comprises or operates in connection with digital software applications such as: ADOBE® EXPRESS®, ADOBE® PHOTOSHOP®, ADOBE® PHOTOSHOP® ELEMENTS, ADOBE® ILLUSTRATOR®, ADOBE® INCOPY, ADOBE® INDESIGN®, and ADOBE® DESIGNER, ADOBE® ACROBAT®, ADOBE® XD. The foregoing are either registered trademarks or trademarks of Adobe Inc. in the United States and/or other countries.

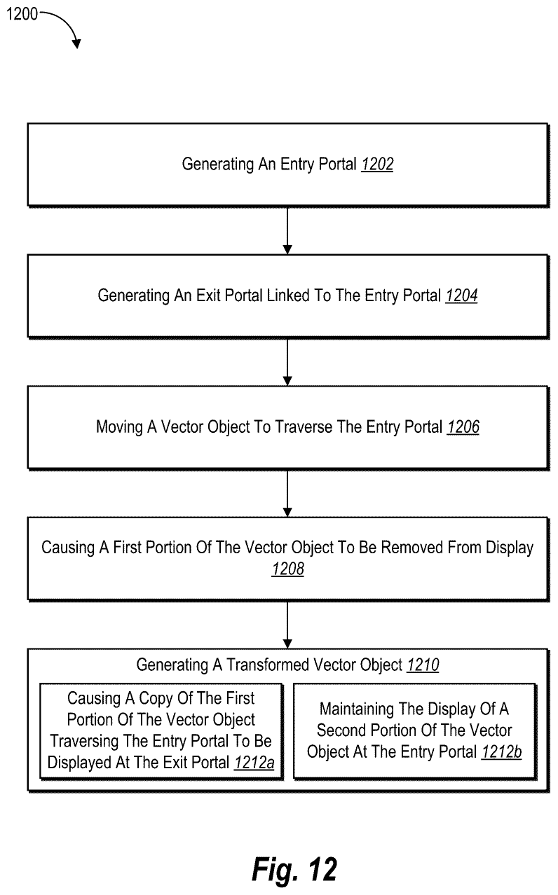

FIGS. 1-11, the corresponding text, and the examples provide a number of different methods, systems, devices, and non-transitory computer-readable media of the relational vector portal system 106. In addition to the foregoing, one or more embodiments are also described in terms of flowcharts comprising acts for accomplishing a particular result, as shown in FIG. 12. In some embodiments, the acts shown in FIG. 12 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIG. 12. In some embodiments, a system is configured to perform the acts of FIG. 12. Alternatively, the acts of FIG. 12 are performed as part of a computer-implemented method.

FIG. 12 illustrates a flowchart of a series of acts for generating a predicted document-summary consistency for a digital summary of a digital document in accordance with one or more embodiments. While FIG. 12 illustrates acts according to one embodiment, alternative embodiments omit, add to, reorder, and/or modify any acts shown in FIG. 12.

FIG. 12 illustrates an example series of acts 1200 for utilizing a relational vector portal system 106 to generate a predicted document-summary consistency. In particular, in certain embodiments, the series of acts 1200 includes an act 1202 of generating an entry portal. Specifically, in one or more embodiments, the act 1202 includes generating, for display on a graphical user interface, an entry portal aligned with a vector path. In particular, in certain embodiments, the series of acts 1200 includes an act 1204 of generating an exit portal linked to the entry portal. In particular, in one or more embodiments, the act 1204 includes generating, for display on the graphical user interface, an exit portal linked to the entry portal. As illustrated, in some embodiments, the series of acts 1200 also includes an act 1206 of moving a vector object to traverse the entry portal. In particular, in one or more embodiments, the act 1206 includes moving, based on a user interaction, a vector object to at least partially traverse the entry portal. In one or more embodiments, the series of acts 1200 also includes an act 1208 of causing a first portion of the vector object to be removed from display. In particular, in one or more embodiments, the act 1208 includes causing a first portion of the vector object traversing the entry portal to be removed from display on the graphical user interface. In certain embodiments, the series of acts 1200 also includes an act 1210 of generating a transformed vector object. In some embodiments, the act 1210 includes a sub-act 1212a of causing a copy of the first portion of the vector object traversing the entry portal to be displayed at the exit portal and a sub-act 1212b of maintaining the display of a second portion of the vector object at the entry portal. Furthermore, in one or more embodiments, the act 1210 includes generating, for display on the graphical user interface, a transformed vector object by causing a copy of the first portion of the vector object traversing the entry portal to exit out of the exit portal while maintaining the display of a second portion of the vector object at the entry portal.

In addition (or in the alternative) to the acts described above, in certain embodiments, the relational vector portal system series of acts 1200 also includes generating the entry portal comprises positioning the entry portal at a first position. In some embodiments, the series of acts 1200 also includes generating the exit portal comprises positioning the exit portal at a second position, such that the second position is different than the first position. Moreover, in one or more embodiments, the relational vector portal system 106 series of acts 1200 includes generating a bidirectional portal comprising the entry portal and the exit portal by generating the entry portal aligned with a first side of the vector path. Further still, in some embodiments, the relational vector portal system 106 series of acts 1200 includes generating a bidirectional portal comprising the entry portal and the exit portal by generating the exit portal aligned with a second side of the vector path opposite the first side of the vector path.

Furthermore, in one or more embodiments, the relational vector portal system series of acts 1200 includes generating the transformed vector object by altering one of a style, a spatial position, an orientation, or a size for the copy of the first portion of the vector object. Moreover, one or more embodiments, the series of acts 1200 includes generating, for display on the graphical user interface, an additional exit portal linked to the entry portal. Further still, in one or more embodiments, the series of acts 1200 includes generating, for display on the graphical user interface, an additional transformed vector object by causing an additional copy of the first portion of the vector object traversing the entry portal to exit out of the additional exit portal.

Moreover, in one or more embodiments, the series of acts 1200 includes providing, for display on a graphical user interface, an additional entry portal linked to an additional exit portal such that the additional entry portal is adjacent to the exit portal and the transformed vector object at least partially traverses the additional entry portal. In certain embodiments, the series of acts 1200 further includes providing, for display on the graphical user interface, an additional transformed vector object by causing a copy of a portion of the transformed vector object traversing the additional entry portal to exit out of the additional exit portal. Moreover, one or more embodiments, the series of acts 1200 includes moving, for display on the graphical user interface, the exit portal to a new position. Furthermore, in one or more embodiments, the series of acts 1200 includes updating the transformed vector object based on the new position for the exit portal. Moreover, in one or more embodiments, the series of acts 1200 includes generating, for display on the graphical user interface, an additional transformed vector object by causing an additional copy of the first portion of the vector object traversing the entry portal to exit out of the exit portal.

In one or more embodiments, the series of acts 1200 includes generating, for display on a graphical user interface, an entry portal linked to an exit portal. Further still, in one or more embodiments, the series of acts 1200 includes determining an intersection path of a vector object with the entry portal. In one or more embodiments, the series of acts 1200 further includes dividing the vector object into a pre-intersection object portion that precedes the entry portal and a post-intersection object portion that has crossed the entry portal, wherein the pre-intersection object portion and the post-intersection object portion are divided along the intersection path into separate objects. In addition, in one or more embodiments, the series of acts 1200 includes positioning a copy of the post-intersection object portion aligned with the exit portal while maintaining the display of the pre-intersection object portion at the entry portal.

Furthermore, in one or more embodiments, the series of acts 1200 includes generating the entry portal aligned with a first vector path at a first position. In addition, in one or more embodiments, the series of acts 1200 includes generating the exit portal aligned with a second vector path at a second position, such that the second position is different than the first position. Moreover, in one or more embodiments, the series of acts 1200 includes generating a bidirectional portal by generating the entry portal aligned with a first side of a vector path. In one or more embodiments, the series of acts 1200 includes generating a bidirectional portal by generating the exit portal aligned with a second side of the vector path. Furthermore, in one or more embodiments, the series of acts 1200 includes generating a transformed vector object by altering a style of the copy of the post-intersection object portion.

In some embodiments, the series of acts 1200 also includes generating, for display on the graphical user interface, an additional exit portal linked to the entry portal. Moreover, in one or more embodiments, the relational vector portal system 106 series of acts 1200 includes positioning an additional copy of the post-intersection object portion at the additional exit portal. Further still, in some embodiments, the relational vector portal system 106 series of acts 1200 includes moving, for display on the graphical user interface, the entry portal to a new position. Furthermore, in one or more embodiments, the relational vector portal system series of acts 1200 includes determine an updated intersection path of a vector object with the entry portal. Moreover, one or more embodiments, the series of acts 1200 includes updating the pre-intersection object portion and the post-intersection object portion based on the updated intersection path.

Further still, in one or more embodiments, the series of acts 1200 includes generating, for display on a graphical user interface, an entry portal linked to an exit portal. Moreover, in one or more embodiments, the series of acts 1200 includes causing, based on a user interaction, a vector object to at least partially traverse the entry portal such that a pre-intersection object portion of the vector object precedes the entry portal, and a post-intersection object portion of the vector object crosses the entry portal. In certain embodiments, the series of acts 1200 further includes causing the post-intersection object portion to be removed from display on the graphical user interface while maintaining display of the pre-intersection object portion. Moreover, one or more embodiments, the series of acts 1200 includes generating, for display on the graphical user interface and aligned with the exit portal, a transformed vector object by performing a transformation on a copy of the post-intersection object portion.

Moreover, one or more embodiments, the series of acts 1200 includes generating the entry portal linked to the exit portal comprises aligning the entry portal with a first side of a vector path and aligning the exit portal with a second side of the vector path. Furthermore, in one or more embodiments, the series of acts 1200 includes performing the transformation on the post-intersection object portion comprises altering a style of the copy of the post-intersection object portion. Moreover, in one or more embodiments, the series of acts 1200 includes comprising generating the transformed vector object by altering one of a style, a spatial position, an orientation, or a size of the copy of the post-intersection object portion. In one or more embodiments, the series of acts 1200 includes generating, for display on the graphical user interface, an additional exit portal linked to the entry portal. Further still, in one or more embodiments, the series of acts 1200 includes generating, for display on the graphical user interface and aligned with the additional exit portal, an additional transformed vector object by performing an additional transformation on an additional copy of the post-intersection object portion.

In one or more embodiments, the series of acts 1200 further includes generating, for display on a graphical user interface, an additional entry portal linked to an additional exit portal wherein the additional entry portal is adjacent to the exit portal and the transformed vector object at least partially traverses the additional entry portal. In addition, in one or more embodiments, the series of acts 1200 includes generating, for display on the graphical user interface and aligned with the additional exit portal, an additional transformed vector object by performing an additional transformation on a portion of the transformed vector object that at least partially traverses the additional entry portal. Furthermore, in one or more embodiments, the series of acts 1200 includes generating, for display on the graphical user interface at an additional position aligned with the exit portal, an additional transformed vector object by performing an additional transformation on an additional copy of the post-intersection object portion.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., server device(s) 102, client device(s) 110, and computing device 1300). In one or more embodiments, the computing device 1300 may be a mobile device (e.g., a mobile telephone, a smartphone, a PDA, a tablet, a laptop, a camera, a tracker, a watch, a wearable device, etc.). In some embodiments, the computing device 1300 may be a non-mobile device (e.g., a desktop computer or another type of client device). Further, the computing device 1300 may be a server device that includes cloud-based processing and storage capabilities.

As shown in FIG. 1, the computing device 1300 can include one or more processor(s) 1302, memory 1304, a storage device 1306, I/O interfaces 1308 (or “input/output interfaces”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular embodiment.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
generating, for display on a graphical user interface, an entry portal aligned with a vector path;
generating, for display on the graphical user interface, an exit portal linked to the entry portal;
moving, based on a user interaction, a vector object to at least partially traverse the entry portal;
causing a first portion of the vector object traversing the entry portal to be removed from display on the graphical user interface; and
generating, for display on the graphical user interface, a transformed vector object by causing a copy of the first portion of the vector object traversing the entry portal to exit out of the exit portal while maintaining the display of a second portion of the vector object at the entry portal.

2. The computer-implemented method of claim 1, wherein:
generating the entry portal comprises positioning the entry portal at a first position; and
generating the exit portal comprises positioning the exit portal at a second position, such that the second position is different than the first position.

3. The computer-implemented method of claim 1, wherein generating the entry portal and generating the exit portal further comprises generating a bidirectional portal comprising the entry portal and the exit portal by:
generating the entry portal aligned with a first side of the vector path; and
generating the exit portal aligned with a second side of the vector path opposite the first side of the vector path.

4. The computer-implemented method of claim 1, further comprising generating the transformed vector object by altering one of a style, a spatial position, an orientation, or a scale for the copy of the first portion of the vector object.

5. The computer-implemented method of claim 1, further comprising:
generating, for display on the graphical user interface, an additional exit portal linked to the entry portal; and
generating, for display on the graphical user interface, an additional transformed vector object by causing an additional copy of the first portion of the vector object traversing the entry portal to exit out of the additional exit portal.

6. The computer-implemented method of claim 1, further comprising:
providing, for display on a graphical user interface, an additional entry portal linked to an additional exit portal such that:
the additional entry portal is adjacent to the exit portal; and
the transformed vector object at least partially traverses the additional entry portal; and
providing, for display on the graphical user interface, an additional transformed vector object by causing a copy of a portion of the transformed vector object traversing the additional entry portal to exit out of the additional exit portal.

7. The computer-implemented method of claim 1, further comprising:
moving, for display on the graphical user interface, the exit portal to a new position; and
updating the transformed vector object based on the new position for the exit portal.

8. The computer-implemented method of claim 1, further comprising generating, for display on the graphical user interface, an additional transformed vector object by causing an additional copy of the first portion of the vector object traversing the entry portal to exit out of the exit portal.

9. A system comprising:
one or more memory devices; and
one or more processors configured to cause the system to:
generate, for display on a graphical user interface, an entry portal linked to an exit portal;
determine an intersection path of a vector object with the entry portal;
divide the vector object into a pre-intersection object portion that precedes the entry portal and a post-intersection object portion that has crossed the entry portal, wherein the pre-intersection object portion and the post-intersection object portion are divided along the intersection path into separate objects; and
position a copy of the post-intersection object portion aligned with the exit portal while maintaining the display of the pre-intersection object portion at the entry portal.

10. The system of claim 9, wherein generating the entry portal linked to the exit portal further comprises:
generating the entry portal aligned with a first vector path at a first position; and
generating the exit portal aligned with a second vector path at a second position, such that the second position is different than the first position.

11. The system of claim 9, wherein generating the entry portal linked to the exit portal further comprises generating a bidirectional portal by:
generating the entry portal aligned with a first side of a vector path; and
generating the exit portal aligned with a second side of the vector path.

12. The system of claim 9, further comprising generating a transformed vector object by altering a style of the copy of the post-intersection object portion.

13. The system of claim 9, further comprising:
generating, for display on the graphical user interface, an additional exit portal linked to the entry portal; and
positioning an additional copy of the post-intersection object portion at the additional exit portal.

14. The system of claim 9, further comprising:
moving, for display on the graphical user interface, the entry portal to a new position;
determine an updated intersection path of a vector object with the entry portal; and
updating the pre-intersection object portion and the post-intersection object portion based on the updated intersection path.

15. A non-transitory computer readable medium storing executable instructions which, when executed by a processing device, cause the processing device to perform operations comprising:
generating, for display on a graphical user interface, an entry portal linked to an exit portal;
causing, based on a user interaction, a vector object to at least partially traverse the entry portal such that a pre-intersection object portion of the vector object precedes the entry portal and a post-intersection object portion of the vector object crosses the entry portal;
causing the post-intersection object portion to be removed from display on the graphical user interface while maintaining display of the pre-intersection object portion; and
generating, for display on the graphical user interface and aligned with the exit portal, a transformed vector object by performing a transformation on a copy of the post-intersection object portion.

16. The non-transitory computer readable medium of claim 15, wherein:
generating the entry portal linked to the exit portal comprises aligning the entry portal with a first side of a vector path and aligning the exit portal with a second side of the vector path; and
performing the transformation on the post-intersection object portion comprises altering a style of the copy of the post-intersection object portion.

17. The non-transitory computer readable medium of claim 15, further comprising generating the transformed vector object by altering one of a style, a spatial position, an orientation, or a size of the copy of the post-intersection object portion.

18. The non-transitory computer readable medium of claim 15, further comprising:
generating, for display on the graphical user interface, an additional exit portal linked to the entry portal; and
generating, for display on the graphical user interface and aligned with the additional exit portal, an additional transformed vector object by performing an additional transformation on an additional copy of the post-intersection object portion.

19. The non-transitory computer readable medium of claim 15, further comprising:
generating, for display on a graphical user interface, an additional entry portal linked to an additional exit portal wherein the additional entry portal is adjacent to the exit portal and the transformed vector object at least partially traverses the additional entry portal; and
generating, for display on the graphical user interface and aligned with the additional exit portal, an additional transformed vector object by performing an additional transformation on a portion of the transformed vector object that at least partially traverses the additional entry portal.

20. The non-transitory computer readable medium of claim 15, further comprising generating, for display on the graphical user interface at an additional position aligned with the exit portal, an additional transformed vector object by performing an additional transformation on an additional copy of the post-intersection object portion.
